(19) United States
(12) Patent Application Publication
(10) Pub. No.: US 2010/0245512 A1
(43) Pub. Date: Sep. 30, 2010

(54) INKJET RECORDING METHOD

(75) Inventors: Hideki KAIMOTO, Shizuoka-ken (JP); Ryoichi NAKANO, Shizuoka-ken (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/714,559

(22) Filed: Mar. 1, 2010

(30) Foreign Application Priority Data
Mar. 30, 2009 (JP) 2009-082534

(51) Int. Cl. B41J 2/01

(52) U.S. Cl. 347/102

(57) ABSTRACT

Disclosed is an inkjet recording method including recording an image by applying at least one of an ink containing a water-soluble dye of Formula (M), an ink containing a water-soluble dye of Formula (BK), an ink containing a water-soluble dye of Formula (Y), and an ink containing a water-soluble dye of Formula (C) according to an inkjet process, to an inkjet recording medium produced by a method including forming an undercoat layer containing a binder resin and a water-soluble divalent metal salt, to a support; forming a coating film containing at least inorganic fine particles and an acetoacetyl-modified polyvinyl alcohol, on the undercoat layer; and applying a curing solution containing a water-soluble multifunctional compound having two or more amino groups in the molecule, to the coating film, either simultaneously with the forming of the coating film or before the coating film undergoes decreasing-rate drying during drying of the coating film.

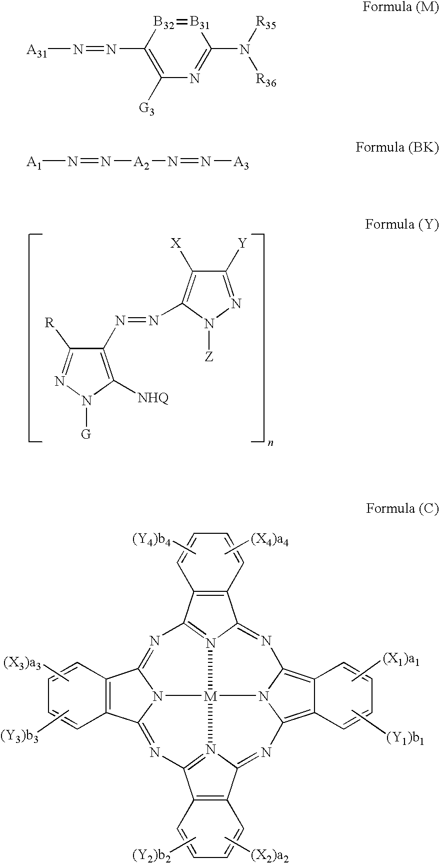

This application is based on and claims priority under 35 USC 119 from Japanese Patent Application No. 2009-082534 filed on Mar. 30, 2009, the disclosure of which is incorporated herein by reference in its entirety.

### BACKGROUND OF THE INVENTION

1. Field of the Invention

The present invention relates to an inkjet recording method.

2. Description of the Related Art

In regard to inkjet recording methods, inkjet recording media in which the recording layer for receiving ink is constituted of a porous structure for the purpose of improving general properties, have been proposed and put into practical use. For example, there is available an inkjet recording medium in which a recording layer containing inorganic pigment particles and a water-soluble binder, and having high porosity has been provided on a support. Since such an inkjet recording medium has a porous structure, the inkjet recording medium has excellent ink receptivity (quick-drying property) and high glossiness, and thus is widely used as a material capable of recording photograph-like images.

A recording layer having high porosity, which is formed by using inorganic pigment particles and a water-soluble binder, generally has particles of small size and a high content of particles. Therefore, after applying a coating liquid to form a film, cracks may be generated in the formed film during drying the film. These cracks are prone to occur, particularly in the case of, for example, drying at a relatively high temperature so as to shorten the drying time, and the cracks are likely to occur during drying after the coating, specifically during the period of transition from constant-rate drying to decreasing-rate drying.

As a method of preventing cracks, a method of increasing the viscosity of the binder in the coating liquid has been known. However, viscosity increase is not desirable from the viewpoint of, for example, unevenness in the coating. In another method, cracks that occur during drying after coating can be prevented by using a binder such as acetoacetyl-modified polyvinyl alcohol in combination with a crosslinking agent.

Meanwhile, from the viewpoint of recording photograph-like images, it is important that bleeding of ink (i.e., the image) does not occur after recording, and as a method of preventing the bleeding of ink, there are known methods of incorporating a cationic polymer, a polyvalent metal compound or the like into the recording layer on which the ink is to be deposited, or of using water-soluble cellulose derivatives.

In relation to the cracks or ink bleeding described above, a recording material for inkjet printing provided with an ink receiving layer which includes a two-layered coating layer formed by simultaneously applying an ink receiving layer which contains a resin binder having a keto group, and an ink receiving layer which contains a crosslinking agent, to be adjacent to each other (see, for example, Japanese Patent Application Laid-Open (JP-A) No. 2005-199671), or an inkjet recording sheet formed by sequentially multi-layer coating an undercoat layer containing a binding agent, a crosslinking agent and a water-soluble cellulose derivative as main components, and an ink-receiving layer containing inorganic fine particles and an acetoacetyl-modified polyvinyl alcohol as main components (see, for example, JP-A No. 2005-271441), have been disclosed. It is suggested that the former is free from cracks and has excellent water resistance, while the latter has high film strength.

There is also disclosed a method for manufacturing an inkjet recording medium, the method including applying a colorant receiving layer coating liquid containing a dispersion of inorganic fine particles dispersed in an aqueous medium containing a hardening agent and a dispersant. The colorant receiving layer coating liquid also contains hydroxypropyl cellulose and/or a cationic urethane resin (see, for example, JP-A No. 2004-358774). It is suggested that, according to this method, favorable dispersibility of the inorganic fine particles is achieved, and bleeding with a lapse of time does not occur.

Furthermore, a recording method of using an inkjet recording medium has also been disclosed (see, for example, JP-A No. 2007-196396). The inkjet recording medium is produced by incorporating a water-soluble metal salt into an ink receiving layer in order to enhance the ozone resistance of images in the case where a dye, particularly a phthalocyanine-based dye, is used as a colorant.

### SUMMARY OF THE INVENTION

However, although attempts have been made to alleviate the brittleness such as cracks or the like, and to enhance the ozone resistance of, for example, an ink (image) containing a dye, by forming an ink receiving layer using an acetoacetyl-modified polyvinyl alcohol, a crosslinking agent therefor and a water-soluble metal salt, there have actually been problems in that the stability of the coating liquid for forming a layer for receiving ink is markedly deteriorated, and the images obtained after printing has decreased moisture resistance.

The present invention was achieved under such circumstances as described above, and provides an inkjet recording method whereby a high print density is obtained and excellence in moisture resistance, light resistance and ozone resistance is attained.

Specifically, according to an aspect of the invention, there is provided the following inkjet recording method.

<1> An inkjet recording method including:

recording an image by applying at least one ink selected from the group consisting of an ink containing a water-soluble dye represented by the following Formula (M), an ink containing a water-soluble dye represented by the following Formula (BK), an ink containing a water-soluble dye represented by the following Formula (Y), and an ink containing a water-soluble dye represented by the following Formula (C) according to an inkjet process, on an inkjet recording medium produced by a method including:

forming an undercoat layer by applying an undercoat layer-forming liquid containing a binder resin and a water-soluble divalent metal salt, to a support;

forming a coating film by coating a coating film-forming liquid containing at least inorganic fine particles and an acetoacetyl-modified polyvinyl alcohol, on the undercoat layer; and

applying a curing solution containing a water-soluble multifunctional compound having two or more amino groups in the molecule, to the coating film either simultaneously with the forming of the coating film or before the coating film undergoes decreasing-rate drying during drying of the coating film.

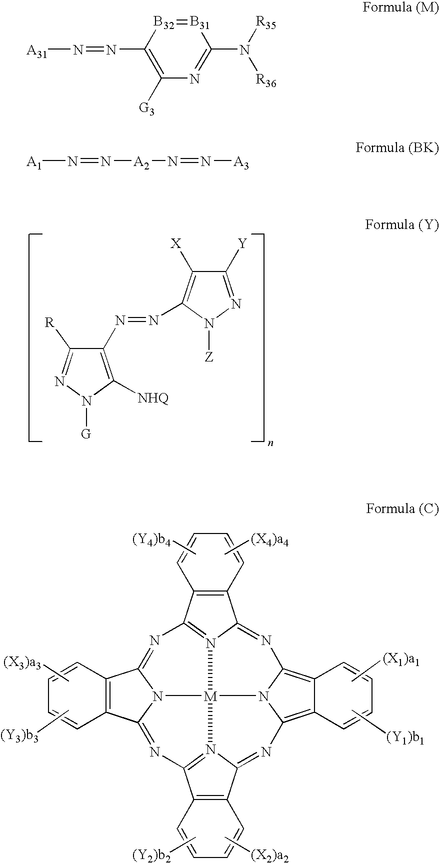

In Formula (M), A₃₁ represents a 5-membered heterocyclic group. B₃₁ and B₃₂ each represent ═CR₃₁—, or —CR₃₂═ or, alternatively one of B₃₁ and B₃₂ is a nitrogen atom, and the other is ═CR₃₁—, or —CR₃₂═. R₃₅ and R₃₆ each independently represent a hydrogen atom, an aliphatic group, an aromatic group, a heterocyclic group, an acyl group, an alkoxycarbonyl group, an aryloxycarbonyl group, a heterocyclic oxycarbonyl group, a carbamoyl group, an alkylsulfonyl group, an arylsulfonyl group, a heterocyclic sulfonyl group, or a sulfamoyl group.

G₃, R₃₁, and R₃₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including arylamino groups and heterocyclic amino groups), an acylamino group, a ureido group, a sulfamoylamino group, an alkoxycarbonylamino group, an aryloxycarbonylamino group, an alkyl or arylsulfonylamino group, a heterocyclic sulfonylamino group, a nitro group, an alkyl or arylthio group, an alkyl or arylsulfonyl group, a heterocyclic sulfonyl group, an alkyl or arylsulfinyl group, a heterocyclic sulfinyl group, a sulfamoyl group, a sulfonic acid group or a heterocyclic thio group.

R₃₁ and R₃₅, or R₃₅ and R₃₆, may bond with each other to form a 5- or 6-membered ring. Herein, at least one of A₃₁, R₃₁, R₃₂, R₃₅, R₃₆ and G₃ has a sulfonic acid group, and the sulfonic acid group has Li⁺ or a quaternary ammonium ion as a counter ion.

In Formula (BK), A₁, A₂, and A₃ each independently represent an aromatic group, or a heterocyclic group. A₁ and A₃ are a monovalent group, and A₂ is a divalent group.

In formula (Y), G represents a heterocyclic group; R, X, Y, Z, and Q each represent a monovalent, divalent, or trivalent group. n represents an integer of 1 to 3. When n is 1, R, X, Y, Z, Q and G each represent a monovalent group. When n is 2, R, X, Y, Z, Q and G each represent a monovalent group or a divalent substituent provided that at least one of R, X, Y, Z, Q or G represents a divalent substituent. When n is 3, R, X, Y, Z, Q and G each represent a monovalent group, a divalent substituent, or a trivalent substituent, and at least two of R, X, Y, Z, Q or G represent a divalent substituent, or at least one of R, X, Y, Z, Q or G represents a trivalent substituent.

In Formula (C), X₁, X₂, X₃, and X₄ each independently represent any of —SO—Z, —SO₂—Z, —SO₂NV₁V₂, —CONV₁V₂, —CO₂Z, —CO—Z, and a sulfo group. In Formula (C), each Z independently represents an alkyl group, a cycloalkyl group, an alkenyl group, an alkynyl group, an aralkyl group, an aryl group, or a heterocyclic group.

V₁ and V₂ may be the same or different and each represent a hydrogen atom, an alkyl group, a cycloalkyl group, an alkenyl group, an alkynyl group, an aralkyl group, an aryl group, or a heterocyclic group. Each of the substituents represented by Z, V₁ and V₂ may further have a substituent.

Y₁, Y₂, Y₃, and Y₄ each independently represent a hydrogen atom, a halogen atom, an alkyl group, a cycloalkyl group, an alkenyl group, an aralkyl group, an aryl group, a heterocyclic group, a cyano group, a hydroxy group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group. Each group may further have a substituent.

a₁ to a₄ and b₁ to b₄ each represent the number of substituents of X₁ to X₄ and Y₁ to Y₄, respectively. a₁ to a₄ each independently represent an integer of from 0 to 4, provided that a₁ to a₄ are not all 0 at the same time. b₁ to b₄ each independently represent an integer of from 0 to 4.

M represents a hydrogen atom, a metal atom, oxides thereof, hydroxides thereof, or halides thereof. Herein, at least one of X₁, X₂, X₃, X₄, Y₁, Y₂, Y₃, or Y₄ is an ionic hydrophilic group or a group having an ionic hydrophilic group as a substituent.

### DETAILED DESCRIPTION OF THE INVENTION

Hereinafter, the inkjet recording method of the present invention will be described in detail.

<2> The inkjet recording method described in <1>, wherein the curing solution further contains inorganic fine particles and a polyvinyl alcohol other than the acetoacetyl-modified polyvinyl alcohol.
<3> The inkjet recording method described in <1> or <2>, wherein the coating film-forming liquid comprises a first solution containing at lest inorganic fine particles and acetoacetyl-modified polyvinyl alcohol and a second solution containing at least inorganic fine particles and a polyvinyl alcohol other than the acetoacetyl-modified polyvinyl alcohol, and the forming of the coating film comprises a process of forming a multi-layered coating film by a simultaneous multilayer coating so that the second solution is disposed above the first solution.
<4> The inkjet recording method described in any one of <1> to <3>, wherein at least one of the first solution or the second solution contains a water-soluble cellulose.
<5> The inkjet recording method described in any one of <1> to <4>, wherein the coating film-forming liquid contains a water-soluble aluminum solution.
<6> The inkjet recording method described in any one of <3> to <5>, wherein the curing solution further contains inorganic fine particles and a polyvinyl alcohol other than the acetoacetyl-modified polyvinyl alcohol, and according to the simultaneous multilayer coating, in the following order, the first solution, the second solution and the curing solution are coated on the undercoat layer formed on the support, thereby forming a multi-layered coating film on the undercoat layer.
<7> The inkjet recording method described in any one of <1> to <6>, wherein the compound represented by Formula (Y) is a compound represented by Formula (Y-1) described below.
<8> The inkjet recording method described in any one of <1> to <7>, wherein the compound represented by Formula (Y) is a yellow dye having an oxidation potential that is more noble than 1.0 V (SCE).
<9> The inkjet recording method described in any one of <1> to <8>, wherein the compound represented by Formula (Y) is a yellow dye having a value of λmax in the range of 390 nm to 470 nm and having a ratio of I (λmax+70 nm)/I (λmax) of 0.2 or less wherein I (λmax+70 nm) represents light absorbance at λmax+70 nm and I (λmax) represents light absorbance at max.
<10> The inkjet recording method described in any one of <1> to <9>, wherein the compound represented by Formula (C) is a compound represented by Formula (C-2) described below or a salt thereof.
<11> The inkjet recording method described in any one of <1> to <10>, wherein the compound represented by Formula (C) is a compound represented by Formula (C-3) described below, or a salt thereof.
<12> The inkjet recording method described in any one of <1> to <11>, wherein a cyan ink having a relatively high color density and a cyan ink having a relatively low color density are contained in an ink set as the cyan ink and the cyan ink having a relatively low color density contains a compound represented by Formula (C-4) described below or a salt thereof.
<13> The inkjet recording method described in any one of <1> to <12>, wherein the binder resin in the undercoat layer is gelatin or polyvinyl alcohol.
<14> The inkjet recording method described in any one of <1> to <13>, wherein the water-soluble divalent metal salt in the undercoat layer is a water-soluble magnesium salt or a water-soluble calcium salt.
<15> The inkjet recording method described in any one of <1> to <14>, wherein the water-soluble multifunctional compound having two or more amino groups in the molecule in the curing solution is an amine compound or a hydrazine compound.
<16> The inkjet recording method according to claim 1, wherein the support is a resin coated paper.

Inkjet Recording Method

The inkjet recording method of the present invention includes:

an image-recording process of recording an image by applying at least one ink selected from the group consisting of an ink containing a water-soluble dye represented by the following Formula (M), an ink containing a water-soluble dye represented by the following Formula (BK), an ink containing a water-soluble dye represented by the following Formula (Y), and an ink containing a water-soluble dye represented by the following Formula (C) according to an inkjet process, to an inkjet recording medium produced by a method including:

an undercoat layer-forming process of forming an undercoat layer by applying an undercoat layer-forming liquid containing a binder resin and a water-soluble divalent metal salt, to a support;

a coating film-forming process of forming a coating film by coating a coating film-forming liquid containing at least inorganic fine particles and an acetoacetyl-modified polyvinyl alcohol, on the undercoat layer; and

a solution-applying process of applying a curing solution containing a water-soluble multifunctional compound having two or more amino groups in the molecule, to the coating film either simultaneously with the forming of the coating film or before the coating film undergoes decreasing-rate drying during drying of the coating film.

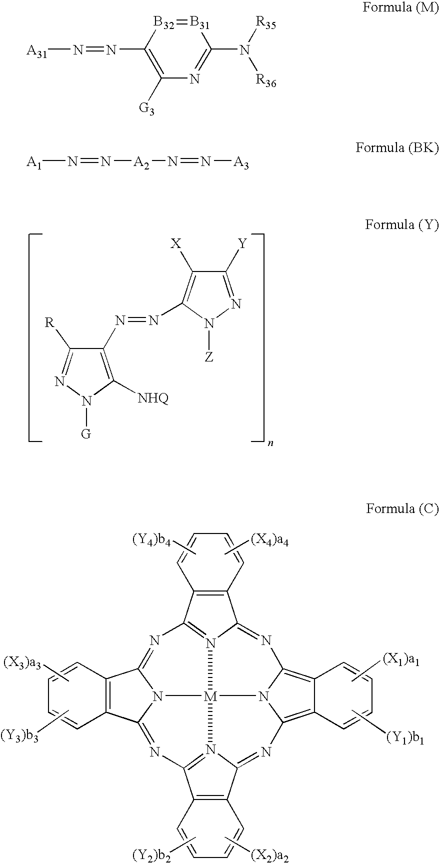

In Formula (M), A₃₁ represents a 5-membered heterocyclic group. B₃₁ and B₃₂ each represent ═CR₃₁—, or —CR₃₂═ or, alternatively one of B₃₁ and B₃₂ is a nitrogen atom, and the other is —CR₃₁═, or —CR₃₂═. R₃₅ and R₃₆ each independently represent a hydrogen atom, an aliphatic group, an aromatic group, a heterocyclic group, an acyl group, an alkoxycarbonyl group, an aryloxycarbonyl group, a heterocyclic oxycarbonyl group, a carbamoyl group, an alkylsulfonyl group, an arylsulfonyl group, a heterocyclic sulfonyl group, or a sulfamoyl group.

G₃, R₃₁, and R₃₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including arylamino groups and heterocyclic amino groups), an acylamino group, a ureido group, a sulfamoylamino group, an alkoxycarbonylamino group, an aryloxycarbonylamino group, an alkyl or arylsulfonylamino group, a heterocyclic sulfonylamino group, a nitro group, an alkyl or arylthio group, an alkyl or arylsulfonyl group, a heterocyclic sulfonyl group, an alkyl or arylsulfinyl group, a heterocyclic sulfinyl group, a sulfamoyl group, a sulfonic acid group or a heterocyclic thio group.

R₃₁ and R₃₅, or R₃₅ and R₃₆, may bond with each other to form a 5- or 6-membered ring. Herein, at least one of A₃₁, R₃₁, R₃₂, R₃₅, R₃₆ and G₃ has a sulfonic acid group, and the sulfonic acid group has Li⁺ or a quaternary ammonium ion as a counter ion.

In Formula (BK), A₁, A₂, and A₃ each independently represent an aromatic group, or a heterocyclic group. A₁ and A₃ are a monovalent group, and A₂ is a divalent group.

In Formula (Y), G represents a heterocyclic group; R, X, Y, Z, and Q each represent a monovalent, divalent, or trivalent group. n represents an integer of 1 to 3. When n is 1, R, X, Y, Z, Q and G, each represent a monovalent group. When n is 2, R, X, Y, Z, Q and G each represent a monovalent group or a divalent substituent provided that at least one of R, X, Y, Z, Q and G represents a divalent substituent. When n is 3, R, X, Y, Z, Q and G each represent a monovalent, divalent, or trivalent group, and at least two of R, X, Y, Z, Q and G represent a divalent substituent, or at least one of R, X, Y, Z, Q and G represents a trivalent substituent.

In Formula (C), X₁, X₂, X₃, and X₄ each independently represent any of —SO—Z, —SO₂—Z, —SO₂NV₁V₂, —CONV₁V₂, —CO₂Z, —CO—Z, and a sulfo group. In Formula (C), each Z independently represents an alkyl group, a cycloalkyl group, an alkenyl group, an alkynyl group, an aralkyl group, an aryl group, or a heterocyclic group.

V₁ and V₂ may be the same or different and each represent a hydrogen atom, an alkyl group, a cycloalkyl group, a alkenyl group, a alkynyl group, na aralkyl group, a aryl group, or a heterocyclic group. Each of the substituents represented by Z, V₁ and V₂ may further have a substituent.

Y₁, Y₂, Y₃, and Y₄ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group. Each group may further have a substituent.

a₁ to a₄ and b₁ to b₄ each represent the number of substituents of X₁ to X₄ and Y₁ to Y₄, respectively. a₁ to a₄ each independently represent an integer of from 0 to 4, provided that a₁ to a₄ are not all 0 at the same time. b₁ to b₄ each independently represent an integer of from 0 to 4.

M represents a hydrogen atom, a metal atom, oxides thereof, hydroxides thereof, or halides thereof. Herein, at least one of X₁, X₂, X₃, X₄, Y₁, Y₂, Y₃, or Y₄ is an ionic hydrophilic group or a group having an ionic hydrophilic group as a substituent.

According to the inkjet recording method of the present invention, an image is recorded on an inkjet recording medium having a particular constitution with an ink containing a particular water-soluble dye, whereby a high print density is obtained and excellence in moisture resistance, light resistance and ozone resistance is attained.

The inkjet recording medium and the ink that are used in the present invention are described below.

Inkjet Recording Medium

The inkjet recording medium used in the present invention is a medium produced by the production method including:

an undercoat layer-forming process of forming an undercoat layer by applying an undercoat layer-forming liquid containing a binder resin and a water-soluble divalent metal salt, to a support;

a coating film-forming process of forming a coating film by coating a coating film-forming liquid containing at least inorganic fine particles and an acetoacetyl-modified polyvinyl alcohol, on the undercoat layer; and

a solution-applying process of applying a curing solution containing a water-soluble multifunctional compound having two or more amino groups in the molecule, to the coating film either simultaneously with the forming of the coating film or before the coating film undergoes decreasing-rate drying during drying of the coating film.

According to the invention, when an ink receiving layer is formed using a film-forming liquid containing an acetoacetyl-modified polyvinyl alcohol (hereinafter, also referred to as an “acetoacetyl-modified PVA”), which has a crack suppressing effect during drying of the coating film, not only an ink-receiving layer can be formed so that the acetoacetyl-modified PVA and “the water-soluble multifunctional compound having two or more amino groups in the molecule” that is a crosslinking agent of the acetoacetyl-modified PVA are not brought into direct contact, but also a water-soluble divalent metal salt as typified by magnesium chloride, which is effective in improving the ozone resistance of image is contained in the undercoat layer. As a result, it is particularly possible to effectively suppress the viscosity increase that otherwise occurs to a great extent when an acetoacetyl-modified PVA and a water-soluble metal salt are used in combination, and the resultant deterioration of the coating properties. Thus, the coating liquid stability in such a composition system is maintained, occurrence of coating film defects such as cracks may be prevented by improving the brittleness after coating (particularly, during drying), and at the same time, moisture resistance or ozone resistance of the image obtained after recording may also be enhanced.

Hereinafter, the respective processes according to the invention are described in detail.

### Process of Forming Undercoat Layer

The present process is a process of forming an undercoat layer by applying an undercoat layer-forming liquid containing a binder resin and a water-soluble divalent metal salt to a support.

### Undercoat Layer-Forming Liquid

### Binder Resin

The undercoat layer-forming liquid for use in the formation of an undercoat layer contains a binder resin and a water-soluble divalent metal salt. As the binder resin, a hydrophilic polymer is preferred considering that later-described aqueous solvents are used as the solvent. Examples of the hydrophilic polymer include polyvinyl alcohol, various modified polyvinyl alcohols, casein, gelatin, and polyvinylpyrrolidone. Among these, gelatin and polyvinyl alcohol are preferably used, and gelatin having a viscosity according to the PAGI method of 10 to 30 mP and jelly strength according to the PAGI method of 15 to 70 g is particularly preferred. When such a binder resin is used, adhesiveness of the ink receiving layer is further enhanced.

Water-Soluble Divalent Metal Salt

Examples of the water-soluble divalent metal salt include water-soluble magnesium salts, water-soluble calcium salts, water-soluble barium salts, water-soluble zinc salts, water-soluble strontium salts, water-soluble titanium salts and water-soluble zirconium salts. Among them, water-soluble magnesium salts or water-soluble calcium salts are preferred.

Here, the term “water-soluble” means that when a saturated aqueous solution of the metal salt is prepared with water at 20° C., the amount of the metal salt contained in 100 g of the saturated solution is 1 g or more. The same applies throughout the application.

The water-soluble magnesium salt is not particularly limited, and known salts may be selected. Examples of the magnesium salt include magnesium chloride, magnesium sulfate, magnesium nitrate, magnesium phosphate, magnesium chlorate, magnesium acetate, magnesium oxalate, and magnesium hydroxide. Among them, magnesium chloride, magnesium sulfate or magnesium nitrate is preferred, with magnesium chloride being particularly preferred.

Examples of the water-soluble calcium salt include calcium chloride, calcium nitrate, calcium sulfate, calcium hydroxide, calcium citrate, calcium phosphate, calcium acetate, and calcium oxalate. Among them, calcium chloride or calcium nitrate is preferred, with calcium chloride being particularly preferred.

The water-soluble divalent metal salt may be used alone, or in combination of two or more kinds thereof.

It is desirable that the content of the water-soluble divalent metal salt in the undercoat layer liquid is set such that the content in the undercoat layer after the coating process is in the range of 0.01 to 1 g/m², and more suitably in the range of 0.02 to 0.5 g/m². By setting the content of the water-soluble divalent metal salt in the layer to be in the aforementioned range, bleeding resistance may be secured, while maintaining ozone resistance of the recorded image.

Furthermore, in this case, the ratio by mass of the water-soluble divalent metal salt to the binder resin in the layer (metal salt/resin) is desirably set to be in the range of 1/20 to 5/5, and more desirably in the range of 1/10 to 4/5.

For the undercoat layer-forming liquid, water, an organic solvent or a mixed solvent thereof may be used as the solvent. Examples of the organic solvent which may be used in the coating include alcohols such as methanol, ethanol, n-propanol, i-propanol or methoxypropanol; ketones such as acetone or methyl ethyl ketone; tetrahydrofuran, acetonitrile, ethyl acetate, and toluene. In this regard, the same applies to the case of preparing the below-described film-forming liquid.

The concentration of solids in the undercoat layer-forming liquid is desirably in the range of 0.1 to 20% by mass, and more suitably in the range of 0.5 to 10% by mass.

Coating of the undercoat layer-forming liquid may be carried out by using a known coating method. Examples of the known coating method include methods of using an extrusion die coater, an air doctor coater, a blade coater, a rod coater, a knife coater, a squeeze coater, a reverse roll coater, and a bar coater.

The amount of coating of the undercoat layer-forming liquid is desirably in the range of 1 to 15 ml/m².

Drying of the undercoat layer-forming liquid after coating is desirably carried out at a temperature of 20 to 100° C. for a period of time of 10 seconds to 5 minutes (particularly, from 20 seconds to 3 minutes). This drying time naturally varies with the amount of coating, but the above-described range is adequate.

The thickness of the undercoat layer is preferably in the range of 0.05 to 5 μm, and more preferably in the range of 0.05 to 2 μm, from the viewpoint of the enhancement of ozone resistance, brittleness, and the adhesiveness of the image-receiving layer.

Support

As the support that is used in the invention, for example, any of a transparent support formed of a transparent material such as plastics and an opaque support constituted of an opaque material such as paper may be utilized. Among them, a resin-coated paper having resin layers respectively provided on both sides of a substrate such as paper is suitable.

According to the invention, polyolefin resin-coated paper is particularly preferred as the resin-coated paper.

The base paper of the polyolefin resin-coated paper is not particularly limited, and any paper that is generally used may be used, but is more preferably, for example, a smooth base paper such as those used as a photographic support. As the pulp constituting the base paper, natural pulp, recycled pulp, synthetic pulp or the like may be used alone or as a mixture of two or more kinds thereof.

In the base paper, additives that are generally used in paper manufacturing, such as a sizing agent, a paper strength enhancing agent, a filling material, an antistatic agent, a fluorescent brightener and a dye, may be incorporated. Furthermore, a surface sizing agent, a surface strengthening agent, a fluorescent brightener, an antistatic agent, a dye, an anchoring agent or the like may also be coated on the surface.

The thickness of the base paper is not particularly limited, but a paper having good surface smoothness that is obtained by, for example, pressing the paper by applying pressure with a calendar or the like, during the paper-making process or after the paper-making process is preferred. The basis weight is preferably in the range of 30 to 250 g/m², and particularly preferably in the range of 50 to 250 g/m².

Examples of the polyolefin resin of the polyolefin resin-coated paper include homopolymers of olefin, such as low density polyethylene, high density polyethylene, polypropylene, polybutene, or polypentene; copolymers formed from two or more olefins, such as ethylene-propylene copolymer; and mixtures thereof. For the polyolefin resins, resins having various densities and melt viscosity indices (melt indices) may be used alone or as mixtures of two or more kinds thereof.

In the polyolefin resin of the polyolefin resin-coated paper, it is preferable to add at least one of various additives, including white pigments such as titanium oxide, zinc oxide, talc, or calcium carbonate; fatty acid amides such as stearic acid amide, or arachidic acid amide; fatty acid metal salts such as zinc stearate, calcium stearate, aluminum stearate, or magnesium stearate; antioxidants such as IRGANOX 1010, or IRGANOX 1076; blue pigments or dyes such as cobalt blue, ultramarine blue, cerulean blue, or phthalocyanine blue; magenta pigments or dyes such as cobalt violet, fast violet, or manganese purple; fluorescent brighteners, ultraviolet absorbents and the like, optionally in combination.

The polyolefin resin-coated paper may be produced by a so-called extrusion coating method in which a molten polyolefin resin obtained by heating is flow cast on a running base paper, whereby one surface or both surfaces of the base paper are coated with the polyolefin resin. Before coating the base paper with the polyolefin resin, it is preferable to subject the surfaces of the base paper to an activation treatment such as a corona discharging treatment or a flame treatment.

The resin-coated paper is preferably constituted such that a polyolefin resin is coated on the surface where an ink receiving layer is applied and formed (this surface is designated as a front surface), but the rear surface on the opposite side is not necessarily required to be coated with a polyolefin resin. However, from the viewpoint of preventing curling, it is preferable that the rear surface is also coated with a polyolefin resin. In this case, the front surface, or if necessary, both front and rear surfaces may be subjected to an activation treatment such as a corona discharge treatment or a flame treatment.

In the case of coating a polyolefin resin, the thickness thereof is preferably in the range of 5 to 50 μm, and particularly preferably in the range of 10 to 45 μm.

The polyolefin resin-coated paper may be provided with various backcoat layers for the purpose of imparting antistatic properties, conveyability, curl preventability and the like. The backcoat layers may contain at least one of inorganic antistatic agents, organic antistatic agents, hydrophilic binders, latexes, curing agents, pigments, surfactants, or the like optionally in combination. An ink receiving layer may be applied to both sides of the polyolefin resin-coated paper.

Process of Forming Coating Film

In the process of forming a coating film, a coating film-forming liquid containing at least inorganic fine particles and an acetoacetyl-modified polyvinyl alcohol is applied, to the undercoat layer formed on the support, to form a coating film. This coating film functions as the ink receiving layer when the recording medium is used in inkjet recording, and the coating film-forming liquid may also be referred to as “an ink receiving layer-coating liquid.”

In the present process, the formation of a coating film may be carried out by using a single coating film-forming liquid or, may be carried out by using dual coating film-forming liquids (a first solution and a second solution), but as will be described below, it is preferable to conduct the formation by using two coating film-forming liquids, from the viewpoints of obtaining coating liquid stability and avoiding the occurrence of coating defects during the drying of the coating.

Hereinafter, the respective cases are described.

A. Case where the Coating Film Formation is Carried Out with a Single Coating Film Forming Liquid

The single coating film-forming liquid used in this case contains at least inorganic fine particles and an acetoacetyl-modified polyvinyl alcohol.

### Coating Film Forming Liquid

### Inorganic Fine Particles

The inorganic fine particles are preferably selected from particles having an average secondary particle size of 500 nm or less. For example, various known fine particles such as particles of amorphous synthetic silica, alumina, alumina hydrate, calcium carbonate, magnesium carbonate, or titanium dioxide can be used. In particular, fine particles of amorphous synthetic silica, alumina, or alumina hydrate are preferred.

The amorphous synthetic silica can be roughly classified into wet process silica, gas phase process silica and others according to the production method. The wet process silica is further classified into precipitation process silica, gel process silica, and sol process silica according to the production method.

In the case of the precipitation process silica, silica particles which have been produced by reacting sodium silicate with sulfuric acid under alkaline conditions and having undergone particle growth, are subjected to aggregation/precipitation, and then are subjected to processes of filtration, water washing, drying and pulverization/classification, to provide final products. The precipitation process silica is commercially available under the trade names of, for example, NIPSIL from Tosoh Silica Corporation, and TOKUSIL from Tokuyama Corporation.

The gel process silica is produced by reacting sodium silicate with sulfuric acid under acidic conditions. Fine particles are dissolved and reprecipitated so as to bind other primary particles with each other during aging. Resultantly, definite primary particles are lost and relatively hard aggregated particles having an internal void structure are formed. Gel process silica is commercially available under the trade names of, for example, NIPGEL from Tosoh Silica Corporation, and SYLOID and SYLOJET from Grace Japan Co., Ltd. The sol process silica is also known as colloidal silica, and is obtained by heating and aging a silica sol, which is obtainable by double decomposition of sodium silicate with acid or the like, or by passing sodium silicate through an ion-exchange resin layer. The sol process silica is commercially available under the trade name of, for example, SNOWTEX from Nissan Chemical Industries, Ltd.

The gas phase process silica is also known as dry process silica in contrast to the wet process silica, and is generally produced according to a flame hydrolysis method. Specifically, a method of combusting silicon tetrachloride together with hydrogen and oxygen, is generally known, but silanes such as methyltrichlorosilane or trichlorosilane may also be used in place of silicon tetrachloride, either alone or as a mixture with silicon tetrachloride. The gas phase process silica is commercially available under the trade names of AEROSIL from Nippon Aerosil Co., Ltd., and QS TYPE from Tokuyama Corporation.

The gas phase process silica is suitably used by dispersing the gas phase process silica in the presence of a cationic compound so as to obtain an average secondary particle size of 500 nm or less, preferably 10 to 300 nm, and more preferably 20 to 200 nm. As for the dispersion method, it is preferable that the gas phase process silica and a dispersion medium are preliminarily mixed by conventional propeller stirring, turbine type stirring, homomixer type stirring or the like, and then dispersion is performed by an apparatus such as a media mill such as a ball mill, a bead mill or a sand grinder; a pressure type dispersing machine such as high pressure homogenizer or a ultrahigh pressure homogenizer; an ultrasonic dispersing machine, a thin film revolving type dispersing machine, or the like. Here, the term average secondary particle size is an average value of particle sizes of the aggregated particles dispersed in the obtained ink receiving layer, which are measured by observation of the ink receiving layer with an electron microscope.

Furthermore, a wet process silica pulverized to an average secondary particle size of 500 nm or less may also be preferably used. As the wet process silica, a wet process silica having an average primary particle size of 50 nm or less, preferably 3 to 40 nm, and an average aggregated particle size of 5 to 50 μm, is preferred, and it is preferable to use wet process silica fine particles obtained by micropulverizing the aforementioned wet process silica to an average secondary particle size of 500 nm or less, preferably about 20 to 200 nm, in the presence of a cationic compound.

Since a wet process silica produced by a conventional method has an average aggregated secondary particle size of 1 μm or greater, this may be micropulverized before use. As the pulverization method, a wet dispersion method of mechanically pulverizing silica which is dispersed in an aqueous medium is preferred. In this case, since the initial viscosity increase of the dispersion liquid is suppressed so that dispersion at high concentration is made possible, and the pulverization/dispersion efficiency is increased so that the particles can be pulverized to finer particles, a precipitation process silica having an oil absorption amount of 210 ml/100 g or less and an average aggregated secondary particle size of 5 nm or greater is preferred. When a highly concentrated dispersion liquid is used, the productivity of the inkjet recording medium is also enhanced. The oil absorption amount is measured based on the descriptions of JIS K-5101, the disclosure of which is incorporated by reference in its entirety.

In regard to a specific method for obtaining wet process silica fine particles having an average secondary particle size of 500 nm or less, first, wet silica and a cationic compound are mixed in water (the addition may be carried out sequentially, irrespective of the order, or simultaneously), or the respective dispersions or aqueous solutions of the two components are mixed, and the resulting mixture is dispersed by using at least one of dispersing apparatuses such as a saw-toothed blade type dispersing machine, a propeller blade type dispersing machine and a rotor-stator type dispersing machine, to obtain a preliminary dispersion liquid. At this time, an appropriate low boiling solvent or the like may be further added according to necessity. The higher solids concentration the preliminary dispersion liquid has, the more preferable the preliminary dispersion liquid is. However, if the concentration is too high, dispersion becomes impossible, and therefore, a preferred range of the concentration is 15 to 40% by mass, and more preferably 20 to 35% by mass. Subsequently, by imparting stronger mechanical energy, a dispersion of wet process silica fine particles having an average secondary particle size of 500 nm or less is obtained. As the means for imparting mechanical energy, known means such as, for example, media mills such as a ball mill, a bead mill and a sand grinder; pressure type dispersing machines such as a high pressure homogenizer and an ultrahigh pressure homogenizer; an ultrasonic dispersing machine, and a thin film revolving type dispersing machine, may be employed.

In the dispersion of gas phase process silica and wet process silica, a cationic compound may be used.

Examples of the cationic compound include a cationic polymer or a water-soluble metal compound.

As for the cationic polymer, polyethyleneimine, polydiallylamine, polyallylamine, alkylamine polymers, or those polymers having a primary amino group, a secondary amino group, a tertiary amino group or a quaternary ammonium salt group described in JP-A No. 59-20696, JP-A No. 59-33176, JP-A No. 59-33177, JP-A No. 59-155088, JP-A No. 60-11389, JP-A No. 60-49990, JP-A No. 60-83882, JP-A No. 60-109894, JP-A No. 62-198493, JP-A No. 63-49478, JP-A No. 63-115780, JP-A No. 63-280681, JP-A No. 1-40371, JP-A No. 6-234268, JP-A No. 7-125411, JP-A No. 10-193776 and the like, are preferred. Particularly, polydiallylamine derivatives are preferred as the cationic polymer. From the viewpoints of dispersibility and dispersion viscosity, the molecular weight of these cationic polymers is preferably about 2000 to 100,000, and particularly preferably about 2000 to 30,000.

Examples of the water-soluble metal compound include water-soluble polyvalent metal salts. Among them, compounds of aluminum or a Group 4A metal in the Periodic Table (for example, zirconium and titanium) are preferred. Water-soluble aluminum compounds are particularly preferred. Examples of the water-soluble aluminum compounds as inorganic salts include aluminum chloride or a hydrate thereof, aluminum sulfate or a hydrate thereof, and ammonium alum. Furthermore, a basic poly aluminum hydroxide compound, which is an inorganic aluminum-containing cationic polymer, is also preferred. Details of the basic poly aluminum hydroxide compound are described below.

As alumina, γ-alumina which is γ-type crystalline aluminum oxide is preferred, and in particular δ-group crystals are preferred. While it is possible to reduce the primary particle size of γ-alumina to about 10 nm, usually a preferable product is obtained by pulverizing secondary particle crystals having a size of several thousand to several tens of thousand nanometers to an average secondary particle size of 500 nm or less, and preferably about 20 to 300 nm, using an ultrasonic or high pressure homogenizer, a counter-collision jet pulverizer or the like.

Alumina hydrate is represented by Al₂O₃.nH₂O (n=1 to 3). When n is 1, the alumina hydrate has a boehmite structure. When n is greater than 1 and equal to or less than 3, the alumina hydrate has a pseudoboehmite structure. The alumina hydrate may be obtained by known production methods such as hydrolysis of aluminum alkoxide such as aluminum isopropoxide, neutralization of an aluminum salt with alkali, or hydrolysis of aluminate. The average secondary particle size of alumina hydrate is preferably 500 nm or less, and more preferably 20 to 300 nm.

The above-described alumina and alumina hydrate may be used in the form of a dispersion liquid that is dispersed with a known dispersant such as acetic acid, lactic acid, formic acid or nitric acid.

The content of the inorganic fine particles in the single coating film-forming liquid is preferably in the range of 5 to 15% by mass, and more preferably in the range of 7 to 13% by mass, based on the solid contents in the single coating film-forming liquid, from the viewpoints of forming a porous structure with high porosity, thereby imparting ink absorbability.

Acetoacetyl-Modified Polyvinyl Alcohol

The coating film-forming liquid contains at least one acetoacetyl-modified polyvinyl alcohol (acetoacetyl-modified PVA). When the liquid contains an acetoacetyl-modified PVA, cracks in the finally formed ink receiving layer or a decrease in the water resistance can be prevented.

The acetoacetyl-modified PVA may be produced according to a known method such as a reaction between polyvinyl alcohol and diketene. The degree of acetoacetylation is preferably in the range of 0.1 to 20% by mole, and more preferably in the range of 1 to 15% by mole, from the viewpoints of alleviating brittleness such as cracks, and enhancing water resistance. The degree of saponification is preferably 80% by mole or more, and more preferably 85% by mole or more.

The average degree of polymerization of the acetoacetyl-modified PVA is preferably in the range of 500 to 5000, and particularly preferably in the range of 1000 to 4500.

The content of the acetoacetyl-modified PVA in the single coating film-forming liquid is preferably in the range of 15 to 30% by mass, and more preferably in the range of 15 to 25% by mass, based on the inorganic fine particles. When the content of the acetoacetyl-modified PVA is 15% by mass or more, coating film defects such as cracks after the coating (particularly, during drying) may be prevented, and when the content is 30% by mass or less, it is advantageous from the viewpoint of ink absorbability.

Other Components

In addition to the above-described components, the coating film-forming liquid may contain, within the range in which of the effects of the invention is not impaired, other components such as cationic mordants such as cationic polymers, surfactants of cationic, anionic, nonionic, amphoteric, fluorine and silicone types, or high boiling organic solvents, as necessary.

Moreover, such other components may be used also in at least one of the first solution and the second solution that are described below.

Furthermore, the preparation of the coating film-forming liquid containing inorganic fine particles and an acetoacetyl-modified PVA may be carried out by preparing an aqueous dispersion of the inorganic fine particles (for example, gas phase process silica) in advance, and then adding the prepared aqueous dispersion to an acetoacetyl-modified PVA-containing aqueous solution. Alternatively, the PVA-containing aqueous solution may be added to the aqueous dispersion of inorganic fine particles, or the two liquids may be mixed simultaneously. Furthermore, the inorganic fine particles may also be used in a powdered form, instead of the aqueous dispersion of inorganic fine particles, and may be added to the PVA-containing aqueous solution as described above.

After mixing the inorganic fine particles and the acetoacetyl-modified PVA, this mixed liquid may be finely granulated by using a dispersing machine, thereby obtaining an aqueous dispersion having an average particle size of 50 nm or less.

Here, the solvent that is used in the preparation of the coating film-forming liquid is the same as described above.

Coating after coating of the coating film-forming liquid may also be carried out by using a known coating method. Examples of the known coating method include methods of using an extrusion die coater, an air doctor coater, a blade coater, a rod coater, a knife coater, a squeeze coater, a reverse roll coater, a bar coater, or the like.

Drying after coating of the coating film-forming liquid is generally carried out at a temperature of 50 to 180° C., and for a period of 0.5 to 10 minutes (particularly, from 0.5 to 5 minutes). This drying time naturally varies with the amount of coating, but the above-mentioned range is appropriate.

The thickness of the coating film (ink receiving layer) formed by using a single coating film-forming liquid is preferably in the range of 15 to 50 μm, and more preferably in the range of 20 to 40 μm, from the viewpoints of ink absorbability, improvement of both brittleness and cracks during the drying of coating.

B. Case where the Coating Film Formation is Carried Out with Two Coating Film Forming Liquids

In this case, a multilayer coating film is formed by simultaneous multilayer coating of a first solution containing at least inorganic fine particles and an acetoacetyl-modified polyvinyl alcohol (hereinafter, may also be referred to as a “first ink receiving layer-coating liquid”), and a second solution containing at least inorganic fine particles and a polyvinyl alcohol other than acetoacetyl-modified polyvinyl alcohol (hereinafter, may also be referred to as a “second ink receiving layer-coating liquid”), such that the second solution is disposed above the first solution.

Thereby, in the following order, a first coating film formed with the first solution (hereinafter, may be simply referred to as a “first coating film”) and a second coating film formed with the second solution (hereinafter, may be simply referred to as a “second coating film”) are formed on the support. Moreover, hereinafter, the first and second coating solutions for ink receiving layer may be collectively referred to simply as “ink receiving layer-coating liquids”.

First Solution

The first solution is prepared using at least inorganic fine particles and an acetoacetyl-modified polyvinyl alcohol, and as is further described below, may also be prepared using a water-soluble cellulose derivative. The first solution forms an ink receiving layer which absorbs and receives the ink provided from an external source. The first solution may contain other components as well, if necessary.

Details of the inorganic fine particles and acetoacetyl-modified PVA used in the first solution are the same as described above.

The content of the inorganic fine particles in the first solution is preferably in the range of 5 to 15% by mass based on the solids in the first solution, from the viewpoints of forming a porous structure with high porosity, thereby imparting ink absorbability.

Furthermore, the content of the acetoacetyl-modified PVA in the first solution is preferably in the range of 10 to 30% by mass, and more preferably in the range of 15 to 25% by mass, based on the inorganic fine particles. If the content of the acetoacetyl-modified PVA is 10% by mass or more, coating film defects such as cracks after coating (particularly, during the drying) are prevented, and the bleeding (particularly, water resistance) after recording may be suppressed. If the content is 30% by mass or less, it is advantageous from the viewpoint of ink absorbability.

The preparation of the first solution (first ink receiving layer-coating liquid) is carried out, for example, as follows: silica fine particles having an average primary particle size of 10 nm or less are added into water (e.g., 10 to 15% by mass), and this is dispersed with a high speed rotating wet colloid mill (e.g., CLEARMIX (manufactured by M Technique Co., Ltd.)), under the conditions of high speed rotation at preferably 5000 to 20,000 rpm, for example, 10,000 rpm for a period of preferably 10 to 30 minutes, for example, 20 minutes. Subsequently, an aqueous solution containing an acetoacetyl-modified PVA was added thereto, and dispersion is further carried out under the conditions as described above to obtain an aqueous dispersion. The resulting aqueous dispersion is a homogeneous sol, and when the dispersion is applied to a support by the coating method described below, a porous layer having a three-dimensional network structure may be obtained.

The preparation of the first solution containing inorganic fine particles and an acetoacetyl-modified PVA may be carried out by preparing an aqueous dispersion of the inorganic fine particles (for example, gas phase process silica) in advance, and adding the prepared aqueous dispersion to an acetoacetyl-modified PVA-containing aqueous solution. Alternatively, the PVA-containing aqueous solution may be added to the aqueous dispersion of inorganic fine particles, or the two liquids may be mixed simultaneously. Furthermore, the inorganic fine particles may also be used in a powdered form, instead of the aqueous dispersion of inorganic fine particles, and may be added to the PVA-containing aqueous solution as described above.

After mixing the inorganic fine particles and the acetoacetyl-modified PVA, this mixed liquid may be finely granulated by using a dispersing machine, whereby an aqueous dispersion having an average particle size of 50 nm or less is obtained.

Here, the solvent used in the preparation of the first solution is the same as described above. In this regard, the same is equally true of the solvent used in the preparation of the below-described second solution.

Coating of the first solution may be carried out by using a known coating method. Examples of the known coating method include methods of using an extrusion die coater, an air doctor coater, a blade coater, a rod coater, a knife coater, a squeeze coater, a reverse roll coater, a bar coater, or the like.

Drying of the ink receiving layer-coating liquid after coating is generally carried out at 50 to 180° C. for 0.5 to 10 minutes (particularly, 0.5 to 5 minutes). This drying time naturally varies with the amount of coating, but the above-mentioned range is appropriate.

The thickness of the first coating film is preferably in the range of 10 to 35 μm, and more preferably in the range of 25 to 32 μm, in view of alleviating brittleness and cracking during drying of the coating.

Second Solution

The second solution is prepared by using at least inorganic fine particles and a polyvinyl alcohol other than acetoacetyl-modified polyvinyl alcohol, and as described below, may also be prepared by using a water-soluble cellulose derivative. The second solution forms an ink receiving layer which absorbs and receives the ink provided from an external source. The second solution may contain other components as well, if necessary.

The second solution contains at least one type of inorganic fine particles. As the inorganic fine particles that can be used in the second solution, the same inorganic fine particles as those that can be used in the preparation of the first solution may be used. Among them, silica particles are preferred, and gas phase process silica is more preferred.

The content of the inorganic fine particles in the second solution is preferably in the range of 5 to 15% by mass based on the solids in the second solution, from the viewpoints of forming a porous structure with high porosity, thereby imparting ink absorbability.

Polyvinyl Alcohol

The second solution contains at least one polyvinyl alcohol (hereinafter, may be simply abbreviated to “PVA”) other than an acetoacetyl-modified PVA. If the second solution contains the acetoacetyl-modified PVA, when a curing solution is applied in the below-described process for applying a curing solution, the “water-soluble multifunctional compound having two or more amino groups in the molecule” in the curing solution directly contacts the acetoacetyl-modified PVA contained in the second solution, so that viscosity increases and coating properties that are expressed by the state of the coated surface after coating are deteriorated.

The polyvinyl alcohol (PVA) contained in the second solution is advantageous to be a PVA which does not contain an acetoacetyl group capable of reacting with the “water-soluble multifunctional compound having two or more amino groups in the molecule” described below, in view of avoiding viscosity increase at the time of coating, the increase arising from the contact of the curing solution as described below, and resultant deterioration of the state of the coated surface and coating defects. Examples of such a PVA include polyvinyl alcohol, and various modified polyvinyl alcohols other than the acetoacetyl-modified PVA. Among these, polyvinyl alcohol is preferred, and particularly, a polyvinyl alcohol having an average degree of polymerization of 1500 or greater is preferred. When such a PVA is used, the film strength of the ink receiving layer is enhanced.

The content of the polyvinyl alcohol (other than acetoacetyl-modified PVA) in the second solution is preferably in the range of 15 to 30% by mass, and more preferably in the range of 15 to 25% by mass, based on the inorganic fine particles, from the viewpoint of ink absorbability.

The preparation of the second solution (second ink receiving layer-coating liquid) may be carried out in the same manner as the preparation of the first solution (first ink receiving layer-coating liquid).

Coating of the second solution may be carried out by using a known coating method, and the same coating methods as in the first solution may be applied. The second solution may be simultaneously multi-layer coated with the first solution, and in this case, coating methods of using, for example, an extrusion die coater, a curtain flow coater, or the like are preferred.

Furthermore, drying after coating of the second solution may be carried out in the same manner as in the first solution.

The thickness of the second coating film is preferably in the range of 3 to 15 μm, and more preferably in the range of 3 to 10 μm, from the viewpoints of suppressing both cracks during drying of the coating and coating defects.

The ratio of the thickness of the second coating film to the thickness of the first coating film (second coating film/first coating film) is not particularly limited, but from the viewpoint of balancing ink absorbability and the suppression of coating defects, the ratio is preferably set in the range of 1/9 to 4/6, and more preferably in the range of 1/9 to 3/7.

Water-Soluble Cellulose Derivative

At least one of the ink receiving layers which constitute the inkjet recording medium according to the invention is preferably constituted by using a water-soluble cellulose derivative. When the ink receiving layer contains a water-soluble cellulose derivative, a good state of coated surface may be obtained at the time of coating, and the bleeding occurring after an image is recorded on the ink receiving layer may be suppressed (suppression of bleeding indicates improvement of moisture resistance).

Therefore, it is preferable that the coating film-forming liquid contains at least one water-soluble cellulose derivative.

Examples of the water-soluble cellulose derivative include methylcellulose, ethylcellulose, hydroxymethylcellulose, hydroxyethylcellulose, hydroxypropylcellulose, hydroxyethylmethylcellulose, hydroxypropylmethylcellulose, carboxymethylcellulose, carboxyethylcellulose, and aminoethylcellulose. However, the examples should not be limited to the above.

It is preferable that the water-soluble cellulose derivative is contained in the aforementioned single coating film-forming liquid, or in at least one of the first solution and the second solution. However, from the viewpoints of coating liquid stability, suppression of coating defects during drying, and image density, it is preferable that the cellulose derivative is contained in the first solution in the case of using two coating film-forming liquids. Furthermore, an aspect in which both first solution and second solution contain the cellulose derivative is also preferable.

The content of the water-soluble cellulose derivative in the single coating film-forming liquid or the first solution is preferably in the range of 0.5 to 5% by mass, and more preferably in the range of 0.5 to 2% by mass, based on the inorganic fine particles in the solution. If the content of the water-soluble cellulose derivative is 0.5% by mass or more, the bleeding after recording can be suppressed, while if the content is 5% by mass or less, it is advantageous in view of coating liquid stability.

In regard to the method for manufacturing an inkjet recording medium of the invention, it is also acceptable that the first solution does not, or does contain a water-soluble cellulose derivative, and the second solution contains at least one water-soluble cellulose derivative. When the second solution, or the first and second solutions contain a water-soluble cellulose derivative, coating defects such as cracks which may occur after coating (particularly, during drying) are prevented, and the bleeding after recording is suppressed (water resistance is particularly improved).

Examples of the water-soluble cellulose derivatives that are usable in the second solution include the same ones as those usable in the preparation of the first solution, and preferred aspects are also similar.

Water-Soluble Aluminum Compound

It is preferable that at least one layer of the ink receiving layer which constitutes the inkjet recording medium according to the invention contains a water-soluble aluminum compound as a component. When the ink receiving layer contains a water-soluble aluminum compound, water resistance is enhanced, and the bleeding of ink (image) under the influence of moisture such as, for example, high humidity is suppressed.

Therefore, it is also preferable that the coating film-forming liquid contains at least one water-soluble aluminum compound.

When the dual coating film-forming liquids are used in the formation of the dual coating films, it is preferable that the second solution contains a water-soluble aluminum compound. When the second solution contains a water-soluble aluminum compound, water resistance is enhanced, and the bleeding of ink (image) under the influence of moisture such as, for example, high humidity is suppressed.

Examples of the water-soluble aluminum compound include, as inorganic salts, aluminum chloride or a hydrate thereof, aluminum sulfate or a hydrate thereof, and ammonium alum. Furthermore, examples of the water-soluble aluminum compound include a basic poly aluminum hydroxide compound, which is an inorganic aluminum-containing cationic polymer. From the viewpoint of ozone resistance of dyes, the basic polyaluminum hydroxide compound is particularly preferred.

The basic poly aluminum hydroxide compound is a water-soluble poly aluminum hydroxide whose main component is represented by the following formula (1), formula (2) or formula (3), and which stably contains a basic, high molecular weight polynuclear condensed ion, such as [Al₆(OH)₁₅]³⁺, [Al₈(OH)₂₀]⁴⁺, [Al₁₃(OH)₃₄]⁵⁺ or [Al₂₁(OH)₆₀]³⁺:

[Al₂(OH)ₙCl₆₋ₙ]ₘ Formula (1)

[Al(OH)₃]ₙAlCl₃ Formula (2)

Alₙ(OH)ₘCl₍₃ₙ₋ₘ₎ [0<m<3n] Formula (3)

These compounds are available from Taki Chemical Co., Ltd. under the name of poly aluminum chloride (PAC) as water treating agents; from Asada Chemical Co., Ltd. under the name of poly aluminum hydroxide (Paho); from Rikengreen Co., Ltd. under the name of PURACHEM WT; and from other makers for similar purposes, and products of various grades can be used.

Where the water-soluble aluminum compound is contained in the single coating film-forming liquid, the content of the compound is preferably in the range of 1 to 15% by mass, and more preferably in the range of 3 to 10% by mass, based on the inorganic fine particles. Furthermore, when the compound is contained in the second solution, the content of the compound is preferably in the range of 2 to 20% by mass, and more preferably in the range of 3 to 15% by mass, based on the inorganic fine particles. When the content of the water-soluble aluminum compound is equal to or greater than the lower limit value, water resistance may be enhanced, and the bleeding occurring under the influence of the environment (particularly, high humidity) after recording may be suppressed. The content equal to or less than the upper limit value is advantageous from the viewpoint of coating liquid stability.

Process of Applying Solution

The process of applying a solution is a process of applying a curing solution containing a water-soluble multifunctional compound having two or more amino groups in the molecule (water-soluble multifunctional crosslinking agent) to the coating film either simultaneously with the formation of the coating film (preferably including the first coating film and the second coating film; the same applies hereinafter) or before the coating film undergoes decreasing-rate drying during the drying of the coating film, in the process for forming a coating film.

By performing the present process, the water-soluble multifunctional crosslinking agent is prevented from directly contacting the acetoacetyl-modified PVA, and the film strength of the coating film in the constant-rate drying state, which is prior to the decreasing-rate drying state of the coating film, may be enhanced. In other words, a good state of coated surface may be obtained (coating property is maintained), and an ink receiving layer having reduced brittleness such as cracks after coating (particularly, during drying) and also having excellent resistance to ink (image) bleeding (particularly, water resistance) may be obtained.

The curing solution is prepared by using at least a water-soluble multifunctional crosslinking agent, and is used as a crosslinking agent solution which crosslinks and cures at least the coating film (at least the first coating film when the two coating film-forming liquids are used). Furthermore, the curing solution may also contain, according to necessity, other components such as a crosslinking agent for a binder component other than acetoacetyl-modified PVA, or a surfactant. The curing solution is prepared by, for example, mixing a water-soluble multifunctional crosslinking agent and a solvent. As the solvent, water, an organic solvent, or a mixed solvent thereof may be used. As examples of the organic solvent, those usable in the preparation of the undercoat layer-forming liquid may be used.

The curing solution is also preferably a basic solution having pH 7.1 or greater, and from the viewpoint of acceleration of crosslinking, the pH of the aforementioned coating film-forming liquid is preferably in the range of 3 to 5.

In the process of applying a solution according to the invention, the curing solution may be applied during drying of the coating film, before the coating film exhibits decreasing-rate drying. By drying the coating film after application of the curing solution, an ink receiving layer is obtained as a result of crosslinking and curing of the coating film.

The application of the curing solution (crosslinking agent-containing solution) may be carried out by methods such as immersion of the coated support in the crosslinking agent solution, coating of the crosslinking agent solution, spraying of the crosslinking agent solution with a sprayer, or the like.

The term “before . . . exhibits decreasing-rate drying” is usually a period of several minutes immediately after the coating, and in this time period, constant-rate drying is exhibited, which refers to a phenomenon in which the content of the solvent in the coating film decreases proportionally to time. In regard to such period showing constant-rate drying, description is given in Kagaku Kogaku Binran (Handbook of Chemical Engineering) (p. 707 to 712, published by Maruzen Co., Ltd., Oct. 25, 1980), the disclosures of which are incorporated herein by reference in their entirety.

When coating films are formed by multi-layer coating of ink receiving layer-coating liquids, while the coating films (first coating film and second coating film) are exhibiting constant-rate drying after coating of both first ink receiving layer-coating liquid and second ink receiving layer-coating liquid, the aforementioned curing solution may be applied by immersing the coating films in the curing solution or alternatively by coating or spraying the curing solution on the coating film.

When the curing solution (crosslinking agent-containing solution) is applied by coating, known coating methods may be used which utilizes a curtain flow coater, an extrusion die coater, an air doctor coater, a blade coater, a rod coater, a knife coater, a squeeze coater, a reverse roll coater, a bar coater, or the like, in addition to the methods described above. Among them, a method of using an extrusion die coater, a curtain flow coater, a bar coater or the like, whereby the coater does not directly contact the coating film, is preferred.

The amount of the curing solution applied on the coating film is generally in the range of 0.01 to 10 g/m², and preferably in the range of 0.05 to 5 g/m², in terms of the amount of crosslinking agent (including the water-soluble multifunctional crosslinking agent and other crosslinking agents such as boric acid). After the coating of the curing solution, the coating film is generally heated at a temperature of 40 to 180° C. for a period of 0.5 to 30 minutes for drying and curing. It is preferable to heat the coating film at 40 to 150° C. for 1 to 20 minutes.

In the process of applying a solution according to the invention, the curing solution may be applied simultaneously with the forming of the coating film (preferably the first coating film and the second coating film) as described above, that is simultaneously with the coating of the coating film-forming liquid (preferably the first solution and the second solution). In this case, the coating film-forming liquid (ink receiving layer-coating liquid) and the curing solution (crosslinking agent-containing solution) are simultaneously applied to the support such that the coating film-forming liquid (suitably, the first solution) is in contact with the support, and the coating film-forming liquid is cured. In this case, the simultaneous multilayer coating of the ink receiving layer-coating liquid and the crosslinking agent-containing solution may be carried out, for example, by a coating method of using an extrusion die coater or a curtain flow coater. Furthermore, drying after the simultaneous multilayer coating is generally carried out by heating at a temperature of 40 to 150° C. for a period of 0.5 to 10 minutes, and thus the coating film is cured. Further, it is preferable to heat the coating film at a temperature of 40 to 100° C. for a period of 0.5 to 5 minutes.

When simultaneous multilayer coating is carried out with, for example, an extrusion die coater, two or three solutions form a multilayer on the extrusion die coater, that is, before being transferred onto the support. For this reason, in the method of manufacturing an inkjet recording medium used in the invention, more favorable effects may be obtained in the case of performing simultaneous multilayer coating.

The ink receiving layer obtained after the coating and drying may be passed through between roll nips under heating and pressure using, for example, a super calendar or a gloss calendar, whereby surface smoothness, transparency and film strength can be enhanced. However, since such treatment decreases the porosity (that is, since the ink absorbability is decreased), it is important to perform the treatment under conditions which lead to only a small decrease in the porosity.

The thickness of the ink receiving layer formed on the support when it is composed of one layer is preferably in the range of 10 to 35 μm, and the total thickness of the ink receiving layer composed of two or more layers is preferably in the range of 10 to 50 μm.

Here, the respective components of the curing solution, such as the water-soluble multifunctional crosslinking agent, will be described.

### Water-Soluble Multifunctional Compound

The curing solution according to the invention contains at least one water-soluble multifunctional compound having two or more amino groups in the molecule (water-soluble multifunctional crosslinking agent). This water-soluble multifunctional crosslinking agent functions as a crosslinking agent which crosslinks the aforementioned acetoacetyl-modified PVA. According to the invention, since this water-soluble multifunctional crosslinking agent is contained in a third solution so that the agent does not directly contact the acetoacetyl-modified PVA at the time of forming the ink receiving layer, coating defects such as cracks which may occur after coating (particularly, during drying) are prevented, and the bleeding after recording can be suppressed (particularly, water resistance is improved).

Examples of the water-soluble multifunctional compound having two or more amino groups in the molecule include amine compounds and hydrazine compounds.

Examples of the amine compounds include ethylenediamine, propylenediamine, trimethylenediamine, tetramethylenediamine, pentamethylenediamine, hexamethylenediamine, isophoronediamine, dicyclohexylmethane-4,4′-diamine, phenylenediamine, diethylenetriamine, triethylenetetramine, triaminopropane, and polymers having amino groups (for example, polyvinylamine, polyethyleneimine, polyallylamine).

Examples of the hydrazine compounds include carbohydrazide, thiocarbohydrazide, ethylene-1,2-dihydrazine, propylene-1,3-dihydrazine, butylene-1,4-dihydrazine, oxalic acid dihydrazide, propionic acid dihydrazide, malonic acid dihydrazide, succinic acid dihydrazide, glutaric acid dihydrazide, adipic acid dihydrazide, sebacic acid dihydrazide, maleic acid dihydrazide, fumaric acid dihydrazide, itaconic acid dihydrazide, salicylic acid dihydrazide, isophthalic acid dihydrazide, 4,4′-oxybenzenesulfonylhydrazide, and vinyl polymers having hydrazide groups (for example, aminopolyacrylamide).

The content of the water-soluble multifunctional crosslinking agent in the curing solution may vary with the thickness of the coating film, the amount of the acetoacetyl-modified PVA, or the like, but the content is preferably in the range of 0.1 to 5% by mass, and more preferably in the range of 1 to 3% by mass, relative to the amount of the acetoacetyl-modified PVA in the coating film-forming liquid (preferably in the first solution). When the content of the water-soluble multifunctional crosslinking agent is 0.1% by mass or more, coating defects such as cracks which may occur after coating (particularly, during drying) are prevented, and the bleeding after recording can be suppressed (particularly, water resistance is improved). A content of 5% by mass or less is advantageous from the viewpoint of coating liquid stability.

In regard to the process of applying a curing solution according to the invention, a method of forming an ink receiving layer composed of two layers or more by carrying out simultaneous multilayer coating of applying the coating film-forming liquid (suitably, the first solution and the second solution) and applying the curing solution at the same time in the process of forming a coating film described above, is more preferred.

In this case, the process of applying a curing solution may be carried out such that, when a water-soluble multifunctional crosslinking agent is applied onto the coating film by using a curing solution, inorganic fine particles and polyvinyl alcohol (except for acetoacetyl-modified PVA) are further contained in the curing solution to further form a curable coating film on the coating film.

Specifically, when a coating film is formed using the single coating film-forming liquid, a curable coating film is further formed on the coating film, thereby obtaining an inkjet recording medium in which an ink receiving layer constituted of a dual layer structure is provided on a support (the curable coating film also functions as the ink receiving layer). Furthermore, when a coating film is formed using the two coating film-forming liquids, a curable coating film is further formed on the second coating film, thereby obtaining an inkjet recording medium in which an ink receiving layer constituted of a triple layer structure (the curable coating film also functions as the ink receiving layer) is provided on a support.

That is, from the viewpoints of maintaining the crosslinking curing reaction of the coated film (preferably the second coating film), and preventing from brittleness such as cracks or ink bleeding (particularly, a decrease in water resistance), it is preferable to perform simultaneous multilayer coating of the aforementioned coating film-forming liquid (suitably the first solution and the second solution) together with the curing solution which contains at least a water-soluble multifunctional crosslinking agent, inorganic particles and a polyvinyl alcohol other than acetoacetyl-modified PVA, on a support. Furthermore, the water-soluble cellulose derivative which is used in combination with the acetoacetyl-modified polyvinyl alcohol may be contained, when the coating film has a dual layer structure as described above, into one layer or two or more layers selected from three layers of the first coating film, the second coating film and the curable coating film. However, since it is preferable to form such a composition that a water-soluble multifunctional crosslinking agent is not present at a portion at which the water-soluble cellulose derivative is mixed together with acetoacetyl-modified polyvinyl alcohol, it is preferable to include the water-soluble cellulose derivative in at least the first solution.

Specifically, a method may be used in which multiple layers including a first coating film, a second coating film and a curable coating film are formed on a support by simultaneously multilayer-coating, on the support, a first solution containing at least inorganic fine particles and an acetoacetyl-modified polyvinyl alcohol, a second solution containing at least inorganic fine particles and polyvinyl alcohol excluding acetoacetyl-modified polyvinyl alcohol, and a curing solution containing at least a water-soluble multifunctional compound having two or more amino groups in the molecules, inorganic fine particles, and polyvinyl alcohol excluding acetoacetyl-modified polyvinyl alcohol, such that the first solution, the second solution and the curing solution are disposed in this order from the support side, wherein a water-soluble cellulose derivative is incorporated into at least one of the first solution, the second solution and the curing solution.

In this case, the curing solution is prepared using at least a water-soluble multifunctional crosslinking agent, inorganic fine particles and a polyvinyl alcohol other than acetoacetyl-modified PVA, and if necessary, other components may further be used. The preparation of the curing solution containing inorganic fine particles and polyvinyl alcohol (the third ink receiving layer-coating liquid) may be carried out by the same method as in the preparation of the first solution (first ink receiving layer-coating liquid).

Details of the inorganic fine particles, a polyvinyl alcohol other than acetoacetyl-modified polyvinyl alcohol and other components, which are contained as a component in the curing solution, are the same as those of the aforementioned first solution and second solution, and preferred aspects are also similar.

The content of the inorganic fine particles (preferably, silica particles (particularly, gas phase process silica)) in the curing solution is preferably in the range of 5 to 15% by mass, and more preferably in the range of 7 to 13% by mass, based on the solids in the curing solution, from the viewpoints of ink absorbability and coating liquid stability.

The content of the polyvinyl alcohol excluding acetoacetyl-modified PVA in the curing solution is preferably in the range of 15 to 30% by mass, and more preferably in the range of 15 to 25% by mass, based on the inorganic fine particles, from the viewpoints of ink absorbability and coating liquid stability.

In the case of multilayer coating, the thicknesses of the first coating film, the second coating film and the third coating film are not particularly limited, but the thickness ratio of the third coating film/second coating film/first coating film is preferably 1/1/7 to 4/1/5, from the viewpoints of coating defects and the brittleness after coating.

Ink

The inkjet recording method of the invention includes an image-forming process of forming an image by applying at least one ink selected from the group consisting of an ink containing a water-soluble dye represented by the following Formula (M) (hereinafter also referred to as a “magenta ink”), an ink containing a water-soluble dye represented by the following Formula (BK) (hereinafter also referred to as a “black ink”), an ink containing a water-soluble dye represented by the following Formula (Y) (hereinafter also referred to as a “yellow ink”), and an ink containing a water-soluble dye represented by the following Formula (C) (hereinafter also referred to as a “cyan ink”) according to an inkjet process, on the above-described inkjet recording medium.

By combining the inkjet recording medium having the above-described particular composition and the ink containing a water-based dye having the particular chemical structure, it is possible to achieve a density of the recorded image and effects of moisture resistance, light resistance and ozone resistance at a better level.

In the invention, the term “water-soluble dye” means a dye that dissolves in water at 20° C. in a quantity of 1% by mass or more.

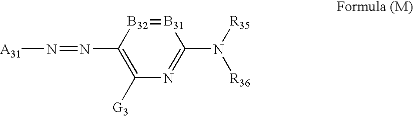

In Formula (M), A₃₁ represents a 5-membered heterocyclic group. B₃₁ and B₃₂ each represent ═CR₃₁—, or —CR₃₂═ or, alternatively one of B₃₁ and B₃₂ is a nitrogen atom, and the other is —CR₃₁═, or —CR₃₂═. R₃₅ and R₃₆ each independently represent a hydrogen atom, an aliphatic group, an aromatic group, a heterocyclic group, an acyl group, an alkoxycarbonyl group, an aryloxycarbonyl group, a heterocyclic oxycarbonyl group, a carbamoyl group, an alkylsulfonyl group, an arylsulfonyl group, a heterocyclic sulfonyl group, or a sulfamoyl group. Each group may further have a substituent.

G₃, R₃₁, and R₃₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including arylamino groups and heterocyclic amino groups), an acylamino group, a ureido group, a sulfamoylamino group, an alkoxycarbonylamino group, an aryloxycarbonylamino group, an alkyl or arylsulfonylamino group, a heterocyclic sulfonylamino group, a nitro group, an alkyl or arylthio group, an alkyl or arylsulfonyl group, a heterocyclic sulfonyl group, an alkyl or arylsulfinyl group, a heterocyclic sulfinyl group, a sulfamoyl group, a sulfonic acid group or a heterocyclic thio group. Each group may be further substituted.

R₃₁ and R₃₅, or R₃₅ and R₃₆, may bond with each other to form a 5- or 6-membered ring. Herein, at least one of A₃₁, R₃₁, R₃₂, R₃₅, R₃₆ and G₃ has a sulfonic acid group, and the sulfonic acid group has Li⁺ or a quaternary ammonium ion as a counter ion.

Examples of the water-soluble dye represented by Formula (M) include dyes having only a sulfonic acid group as a water-soluble group and a lithium ion or a quaternary ammonium ion as a counter anion of the sulfonic acid group, among dyes described on pages 35 to 55 of WO 2002/83795, pages 27 to 42 of WO 2002/83662, paragraphs [0046]-[0059] of JP-A No. 2004-149560 and paragraphs [0047]-[0060] of JP-A No. 2004-149561. Specific examples of especially preferable dyes among water-soluble dyes represented by Formula (M) are shown below in the form of a free acid thereof. However, it is preferable to use these dyes in the form of the above-described salt.

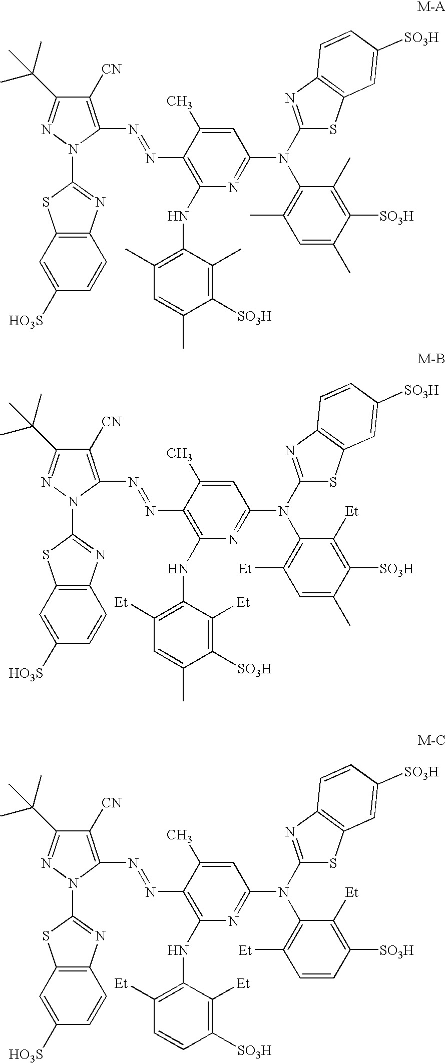

In the invention, the content of the water-soluble dye represented by Formula (M) (heterocyclic azo dye) in the magenta ink is preferably in the range of 0.2 to 20% by mass, and more preferably in the range of 0.5 to 15% by mass.

The magenta ink used in the invention may contain dyes other than the water-soluble dye represented by Formula (M). However, the content of the water-soluble dye represented by Formula (M) based on the total of dyes in the magenta ink is preferably 25% by mass or more, further preferably 50% by mass or more, and still further preferably 60% by mass or more.

A₁-N═N-A₂-N═N-A₃ Formula (BK)

In Formula (BK), A₁, A₂, and A₃ each independently represent an aromatic group which may be substituted, or a heterocyclic group which may be substituted. A₁ and A₃ are a monovalent group, and A₂ is a divalent group. It is preferable that at least one of A₁, A₂, or A₃ is a heterocyclic group.

Example of the water-soluble dye represented by Formula (BK) include water-soluble dyes described in paragraphs [0041]-[0059] of JP-A No. 2007-70573, and a preferable range of these water-soluble dyes is also the same as the preferable range described therein.

In the invention, the content of the water-soluble dye represented by Formula (BK) in the black ink is preferably in the range of 0.2 to 20% by mass, and more preferably in the range of 0.5 to 15% by mass.

The black ink used in the invention may contain dyes other than the water-soluble dye represented by Formula (BK). However, the content of the water-soluble dye represented by Formula (BK) based on the total of dyes in the black ink is preferably 25% by mass or more, further preferably 50% by mass or more, and still further preferably 60% by mass or more.

It is preferable that the ink containing the water-soluble black represented by Formula (BK) used in the invention may further contain a water-soluble short-wave dye.

Specific example of the water-soluble short-wave dye include water-soluble dyes described in paragraphs [0061]-[0072] of JP-A No. 2007-70573, and a preferable range of these water-soluble dyes is also the same as the preferable range described therein.

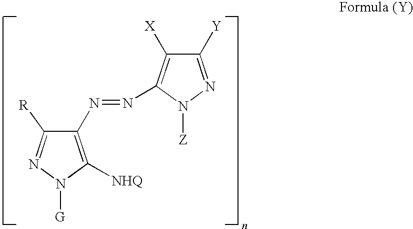

In Formula (Y), G represents a heterocyclic group; R, X, Y, Z, and Q each independently represent a monovalent, divalent, or trivalent group; n represents an integer of 1 to 3; when n is 1, R, X, Y, Z, Q and G each independently represent a monovalent group; when n is 2, R, X, Y, Z, Q and G each independently represent a monovalent or divalent group, and at least one of R, X, Y, Z, Q and G represents a divalent substituent; and when n is 3, R, X, Y, Z, Q and G each independently represent a monovalent, divalent, or trivalent group, and at least two of R, X, Y, Z, Q and G represent a divalent substituent, or at least one of R, X, Y, Z, Q and G represents a trivalent substituent.

The water-soluble dye represented by Formula (Y) functions as a yellow dye. In Formula (Y), preferable examples of G include 5- to 8-membered heterocyclic groups. Among these rings, 5- or 6-membered substituted, or unsubstituted aromatic or non-aromatic heterocyclic groups, which may be condensed, are preferable. Further, 5- or 6-membered aromatic heterocyclic groups having 3 to 30 carbon atoms are more preferable.

Examples of the heterocyclic group represented by the G include those derived from hetero rings described below without specifying a substitution cite of the ring: pyridine, pyrazine, pyridazine, pyrimidine, triazine, quinoline, isoquinoline, quinazoline, cinnoline, phthalazine, quinoxaline, pyrrol, indole, furan, benzofuran, thiophene, benzothiophene, pyrazole, imidazole, benzimidazole, triazole, oxazole, benzoxazole, thiazole, benzothiazole, isothiazole, benzoisothiazole, thiadiazole, isooxazole, benzoisooxazole, pyrrolidine, piperidine, piperazine, imidazolidine, thiazoline, and sulfolane.

If it is possible for the heterocyclic group to have a substituent, the heterocyclic group may further have the substituent.

In Formula (Y), preferable examples of Q, R, X, Y and Z are explained in detail below.

When Q, R, X, Y, and Z represent a monovalent group, the monovalent group represents a hydrogen atom, or a monovalent substituent. The monovalent substituent is detailed below. Examples of the monovalent substituent include a halogen atom, an alkyl group, a cycloalkyl group, an aralkyl group, an alkenyl group, an alkynyl group, an aryl group, a heterocyclic group, a cyano group, a hydroxyl group, a nitro group, an alkoxy group, an aryloxy group, a silyloxy group, a heterocyclic oxy group, an acyloxy group, a carbamoyloxy group, an alkoxycarbonyloxy group, an aryloxycarbonyloxy group; an amino group which may be an alkylamino group, or an aryamino group; an acylamino group (amido), an aminocarbonylamino group (ureido), an alkoxycarbonylamino group, an aryloxycarbonylamino group, a sulfamoylamino group, an alkylsulfonylamino group, an arylsulfonylamino group, an alkylthio group, an arylthio group, a heterocyclic thio group, a sulfamoyl group, an alkylsulfinyl group, an arylsulfinyl group, an alkylsulfonyl group, an arylsulfonyl group, an acyl group, an aryloxycarbonyl group, an alkoxycarbonyl group, a carbamoyl group, a phosphino group, a phosphinyl group, a phosphinyloxy group, a phosphinylamino group, a silyl group, an azo group, or an imido group. Further, each of the above groups may have a substituent.

Of the monovalent group, a hydrogen atom, a halogen atom, an alkyl group, an aryl group, a heterocyclic group, a cyano group, an alkoxy group, an amido group, an ureido group, an alkylsulfonylamino group, an arylsulfonylamino group, a sulfamoyl group, an alkylsulfonyl group, an arylsulfonyl group, a carbamoyl group, or an alkoxycarbonyl group is especially preferable. Furthermore, a hydrogen atom, a halogen atom, an alkyl group, an aryl group, a cyano group, an alkylsulfonyl group, an arylsulfonyl group, or a heterocyclic group is especially preferable. Among these groups, a hydrogen atom, an alkyl group, an aryl group, a cyano group, or an alkylsulfonyl group is most preferable.

In Formula (Y), n is preferably 1 or 2, and especially preferable n is 2.

In Formula (Y), a preferable example of the substituent represented by X is an electron withdrawing group, especially having a Hammett substituent constant σ p of 0.20 or more, and more preferably 0.30 or more. The upper limit of the σ p value of the electron withdrawing group is preferably 1.0.

Specific examples of X that is an electron withdrawing group having the σ p value of 0.20 or more include an acyl group, an acyloxy group, a carbamoyl group, an alkyloxycarbonyl group, an aryloxycarbonyl group, a cyano group, a nitro group, a dialkylphosphono group, a diarylphosphono group, a diarylphosphinyl group, an alkylsulfinyl group, an arylsulfinyl group, an alkylsulfonyl group, an arylsulfonyl group, a sulfonyloxy group, an acylthio group, a sulfamoyl group, a thiocyanate group, a thiocarbonyl group, a halogenated alkyl group, a halogenated alkoxy group, a halogenated aryloxy group, a halogenated alkylamino group, a halogenated alkylthio group, an aryl group substituted with other electron withdrawing group(s) having the σ p value of 0.20 or more, a heterocyclic group, a halogen atom, an azo group, and a selenocyanate group.

Preferable examples of X include an acyl group having 2 to 12 carbon atoms, an acyloxy group having 2 to 12 carbon atoms, a carbamoyl group having 1 to 12 carbon atoms, an alkyloxycarbonyl group having 2 to 12 carbon atoms, an aryloxycarbonyl group having 7 to 18 carbon atoms, a cyano group, a nitro group, an alkylsulfinyl group having 1 to 12 carbon atoms, an arylsulfinyl group having 6 to 18 carbon atoms, an alkylsulfonyl group having 1 to 12 carbon atoms, an arylsulfonyl group having 6 to 18 carbon atoms, a sulfamoyl group having 0 to 12 carbon atoms, a halogenated alkyl group having 1 to 12 carbon atoms, a halogenated alkoxy group having 1 to 12 carbon atoms, a halogenated alkylthio group having 1 to 12 carbon atoms, a halogenated aryloxy group having 7 to 18 carbon atoms, an aryl group having 7 to 18 carbon atoms and substituted with at least two other electron withdrawing groups having the σ p value of 0.20 or more, and a N, O, or S-containing 5- to 8-membered heterocyclic group having 1 to 18 carbon atoms.

X is more preferably a cyano group, an alkylsulfonyl group having 1 to 12 carbon atoms, an arylsulfonyl group having 6 to 18 carbon atoms, or a sulfamoyl group having 0 to 12 carbon atoms.

X is further preferably a cyano group, an alkylsulfonyl group having 1 to 12 carbon atoms, or a sulfamoyl group having 0 to 12 carbon atoms. Still further preferable X is a cyano group, or an alkylsulfonyl group having 1 to 12 carbon atoms.

In Formula (Y), preferable examples of Z include a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, and a substituted or unsubstituted heterocyclic group.

Detailed examples of the heterocyclic group represented by Z are the same as those exemplified as the heterocyclic group represented by G, and preferable examples thereof are also the same as those described as preferable examples of the heterocyclic group represented by G.

Among the substituent represented by Z, a substituted aryl group, or a substituted heterocyclic group is especially preferable, and a substituted aryl group is further preferable.

Examples of the substituted aryl group include a toryl group and an ortho xyryl group.

In Formula (Y), Q is preferably a hydrogen atom, a substituted or unsubstituted alkyl group having 1 to 12 carbon atoms, a substituted or unsubstituted acyl group having 2 to 12 carbon atoms, a substituted or unsubstituted alkylsulfonyl group having 1 to 12 carbon atoms, or a substituted or unsubstituted arylsulfonyl group having 6 to 18 carbon atoms, more preferably a hydrogen atom, a substituted or unsubstituted alkyl group having 1 to 12 carbon atoms, or a substituted or unsubstituted acyl group having 2 to 12 carbon atoms, and furthermore preferably a hydrogen atom.

In Formula (Y), R is preferably a substituted or unsubstituted alkyl group having total carbon atoms of 1 to 12, a substituted or unsubstituted aryl group having total carbon atoms of 6 to 18, or a substituted or unsubstituted heterocyclic group having total carbon atoms of 4 to 12, more preferably a straight chain or branched alkyl group having total carbon atoms of 1 to 8, furthermore preferably a secondary or tertiary alkyl group, and still further preferably a t-butyl group.

In Formula (Y), Y is preferably a hydrogen atom, a substituted or unsubstituted alkyl group having total carbon atoms of 1 to 12, a substituted or unsubstituted aryl group having total carbon atoms of 6 to 18, or a substituted or unsubstituted heterocyclic group having total carbon atoms of 4 to 12, more preferably a hydrogen atom, or a straight chain or branched alkyl group having total carbon atoms of 1 to 8, further preferably a hydrogen atom, or an alkyl group having total carbon atoms of 1 to 8, and still further preferably a hydrogen atom.

As a preferable combination of G, R, X, Y, Z and Q in the dye represented by Formula (Y), compounds in which at least one of G, R, X, Y, Z and Q is an aforementioned preferable group are preferable, and compounds in which two or more of G, R, X, Y, Z and Q are each an aforementioned preferable group are more preferable. Compounds in which all of G, R, X, Y, Z and Q are aforementioned preferable groups are most preferable.

Especially preferable combinations of G, R, X, Y, Z and Q in the dye represented by Formula (Y) include the following exemplary embodiments of (i) to (vii):

(i) G is preferably a 5- to 8-membered nitrogen-containing hetero ring, more preferably a S-triazine, pyrimidine, pyridazine, pyrazine, pyridine, imidazole, pyrazole, or pyrrol ring, further preferably a S-triazine, pyrimidine, pyridazine, or pyrazine, ring, and still further preferably a S-triazine ring.

(ii) R is preferably a substituted or unsubstituted alkyl group having total carbon atoms 1 of 1 to 12, a substituted or unsubstituted aryl group having total carbon atoms of 6 to 18, or a substituted or unsubstituted heterocyclic group having total carbon atoms of 4 to 12, more preferably a straight chain or branched alkyl group having total carbon atoms of 1 to 8, further preferably a secondary or tertiary alkyl group, and still further preferably a t-butyl group.

(iii) X is especially preferably a cyano group, an alkylsulfonyl group having carbon atoms of 1 to 12, an arylsulfonyl group having carbon atoms of 6 to 18, or a sulfamoyl group having carbon atoms of 0 to 12, further preferably a cyano group, or an alkylsulfonyl group having carbon atoms of 1 to 12, and still further preferably a cyano group.

(iv) Y is preferably a hydrogen atom, a substituted or unsubstituted alkyl group having total carbon atoms of 1 to 12, a substituted or unsubstituted aryl group having total carbon atoms of 6 to 18, or a substituted or unsubstituted heterocyclic group having total carbon atoms of 4 to 12, more preferably a hydrogen atom, a straight chain or branched alkyl group having total carbon atoms of 1 to 8, further preferably a hydrogen atom, or an alkyl group having total carbon atoms of 1 to 8, and still further preferably a hydrogen atom.

(v) Z is preferably a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, and a substituted or unsubstituted heterocyclic group, further preferably a substituted aryl group, or a substituted heterocyclic group, and still further preferably a substituted aryl group.

(vi) Q is preferably a hydrogen atom, a substituted or unsubstituted alkyl group, a substituted or unsubstituted acyl group, a substituted or unsubstituted alkylsulfonyl group, or a substituted or unsubstituted arylsulfonyl group, more preferably a hydrogen atom, a substituted or unsubstituted alkyl group, or a substituted or unsubstituted acyl group, and further preferably a hydrogen atom.

(vii) n represents an integer of 1 to 3, preferably 1 or 2, and more preferably 2.

It is preferable that the compound represented by Formula (Y) is a compound represented by the following Formula (Y-1).

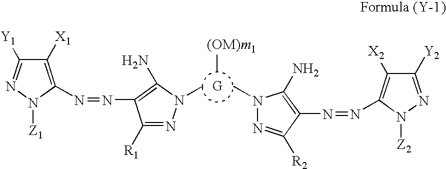

In Formula (Y-1), R₁, R₂, X₁, X₂, Y₁, Y₂, Z₁, and Z₂ each independently represent a monovalent group. G represents an atomic group necessary to form a 5- to 8-membered nitrogen-containing hetero ring. M represents a hydrogen atom or a cation. m₁ represents an integer of 0 to 3.

The compound represented by Formula (Y) is preferably a compound represented by the above-described Formula (Y-1) wherein the nitrogen-containing hetero ring formed by G is a S-triazine ring.

Exemplified dyes DYE-1 to DEY-3 and DYE-10 to DEY-12 are shown below as specific examples of the compound represented by Formula (Y). However, the dyes used in the present invention are not limited to these compounds. For example, those dyes described in JP-A No. 2007-191650 may be also used in the present invention.

Further, even though the chemical structures of the following exemplified compounds are described in the form of free acids, it is obvious that they may be used as a salt thereof. Herein, preferable examples of the counter cation include alkali metals (for example, lithium, sodium, and potassium), ammonium, and organic cations (for example, pyridinium, tetramethyl ammonium, and guanidium).

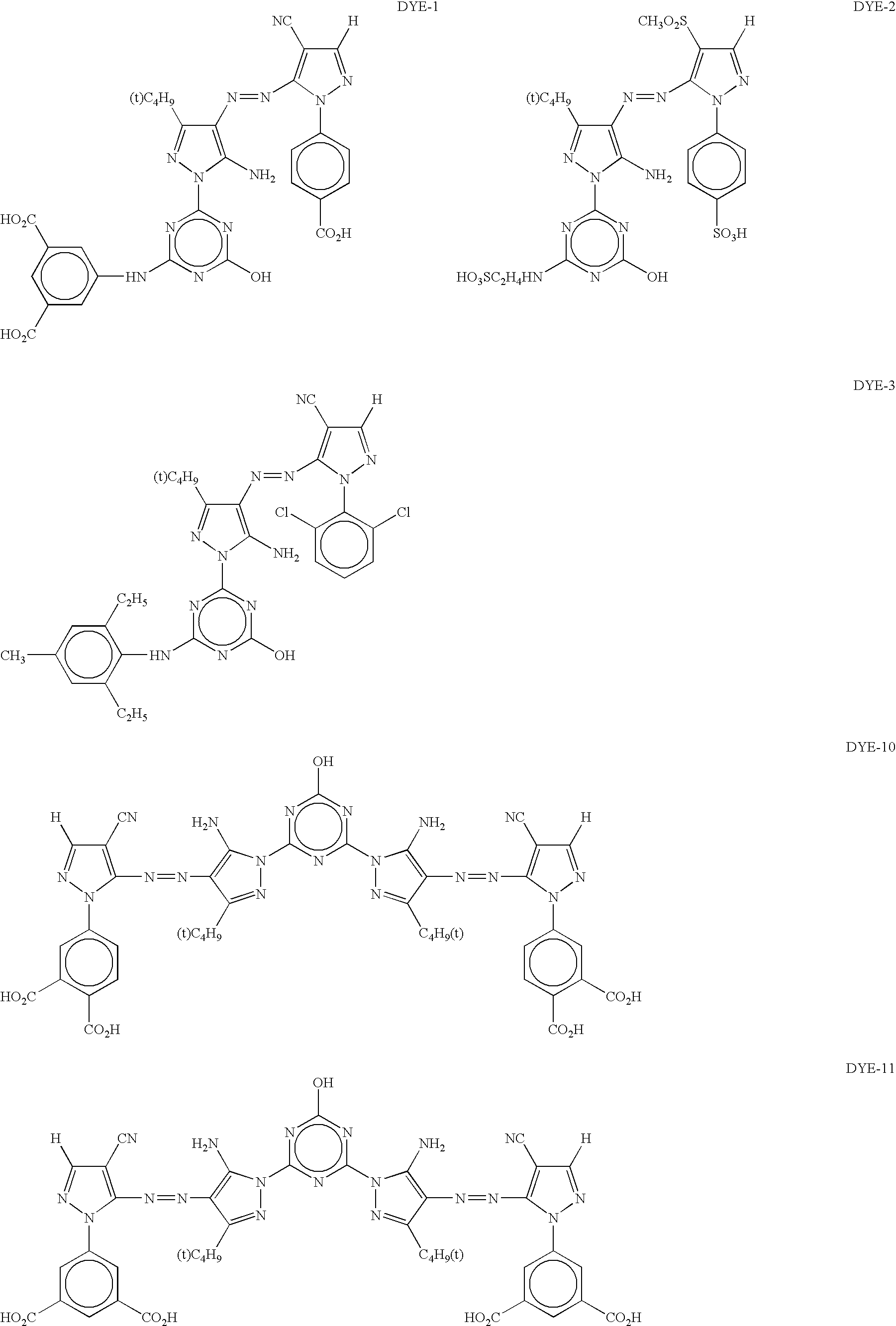

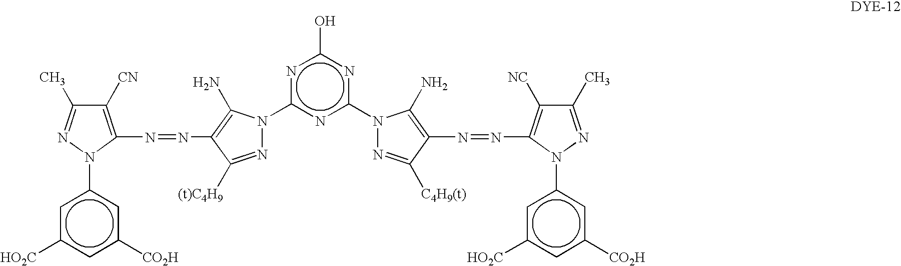

From the viewpoints of fastness, especially fastness to ozone gas, it is preferable that the yellow dye used in the present invention is a dye having an oxidation potential that is more noble than 1.0 V (SCE). It is more preferable to use one having an oxidation potential more noble than 1.1 V (SCE), and it is most preferable to use one having an oxidation potential more noble than 1.2 V (SCE).

The oxidation potential value (Eox) can be easily measured by one skilled in the art and a method therefor is described in, for example, P. Delahay, “New Instrumental Methods in Electrochemistry”, Interscience Publishers (1954), A. J. Bard et al., “Electrochemical Methods”, John Wiley & Sons (1980), and Akira Fujishima et al., “Denkikagaku Sokuteihou” (Electrochemical Measurement Methods), Gihodo Shuppan Sha (1984).

More specifically, a test sample is dissolved so as to be a concentration of 1×10⁻² to 1×10⁻⁶ mol/L in a solvent such as dimethylformamide or acetonitrile containing a supporting electrolyte such as sodium perchlorate or tetrapropylammonium perchlorate. The oxidation potential is measured as a value relative to the SCE (saturated calomel electrode) using various voltammetric methods (polarography using a dropping mercury electrode, cyclic voltammetry, a method using a rotating disc electrode). This value sometimes deviates by on the order of tens of millivolts due to the effect of a liquid junction potential, the liquid resistance of the sample solution, or the like, but the reproducibility of the potential can be guaranteed by adding a standard sample (for example, hydroquinone).

In order to univocally define the potential, the oxidation potential value of a dye used in the present invention is defined as a value (vs SCE) obtained by measuring in a N,N-dimethylformamide solution containing 10⁻³ mol/L of a dye and 0.1 mol/L of tetrapropylammonium perchlorate as a supporting electrolyte using SCE (saturated calomel electrode) as a reference electrode, a graphite electrode as a working electrode and a platinum electrode as a counter electrode.

The value of Eox represents ease of transfer of electrons from a sample to an electrode. The larger the value (the more noble the oxidation potential), the more difficult the transfer of electrons from a sample to an electrode is. In other words, a large value of Eox indicates that the sample is resistant to oxidation. In relation to the chemical structure of a compound, introduction of an electron-attracting group makes the oxidation potential more noble, whereas an electron-donating group makes it more ignoble. In order to decrease reactivity with ozone that is an electrophile, it is desirable in the present invention to introduce an electron-attracting group to the yellow dye skeleton, thereby making the oxidation potential more noble.

It is preferable that the dye used in the invention has good fastness and good hue in combination. When the dye is used in a yellow ink, it is preferable that the dye has a sharp bottom line at the long wavelength side of the characteristic curve in particular. For this reason, the dye is preferably a yellow dye having a value of λmax in the range of 390 nm to 470 nm and having a ratio of light absorbance at λmax+70 nm [I (λmax+70 nm)] to light absorbance at λmax: [I (λmax)], i.e., I (λmax+70 nm)/I (λmax) of 0.2 or less, more preferably 0.15 or less, and further preferably 0.1 or less. The absorption wavelength and the light absorbance herein described are values of the dye measured in a solvent (water or ethyl acetate).

In the present invention, the content of a water-soluble dye (azo dye) represented by Formula (Y) in a yellow ink is preferably from 0.2 to 20% by mass, and more preferably from 0.5 to 15% by mass.

The yellow ink used in the invention may contain a dye other than the water-soluble dye represented by Formula (Y). However, the content of the water-soluble dye represented by Formula (Y) is preferably 25% by mass or more, more preferably 50% by mass or more, and further preferably 60% by mass or more, respectively based on a total of dyes.

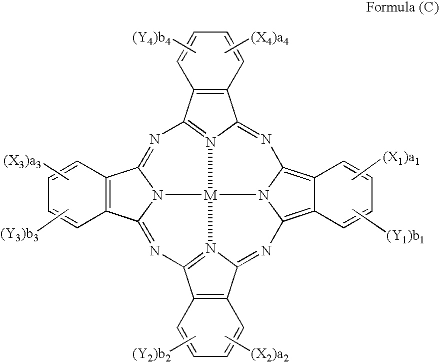

In Formula (C), X₁, X₂, X₃, and X₄ each independently represent any of —SO—Z, —SO₂—Z, —SO₂NV₁V₂, —CONV₁V₂, —CO₂Z, —CO—Z, and a sulfo group. In Formula (C), each Z independently represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. V₁ and V₂ may be the same or different and each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

Y₁, Y₂, Y₃, and Y₄ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group. Each group may further have a substituent.

a₁ to a₄ and b₁ to b₄ each represent the number of substituents of X₁ to X₄ and Y₁ to Y₄, respectively. a₁ to a₄ each independently represent an integer of from 0 to 4, provided that a₁ to a₄ are not all 0 at the same time. b₁ to b₄ each independently represent an integer of from 0 to 4.

M represents a hydrogen atom, a metal atom, oxides thereof, hydroxides thereof, or halides thereof. Herein, at least one of X₁, X₂, X₃, X₄, Y₁, Y₂, Y₃, or Y₄ is an ionic hydrophilic group or a group having an ionic hydrophilic group as a substituent.

In the invention, it is preferable that, in Formula (C), a₁, a₂, a₃, and a₄ be 0 or 1 and two or more of a₁, a₂, a₃, and a₄ be 1. Furthermore, it is preferable that b₁, b₂, b₃, and b₄ each be an integer such that the total of (b₁, b₂, b₃, and b₄) and (a₁, a₂, a₃, and a₄) gets 4.

As described above, in Formula (C), X₁, X₂, X₃ and X₄ each independently represent any of —SO—Z, —SO₂—Z, —SO₂NV₁V₂, —CO₂NV₁V₂, —CO₂Z, —CO—Z, and a sulfo group.

Zs may be the same or different and each represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

A substituted or unsubstituted alkyl group, a substituted or unsubstituted aryl group, or a substituted or unsubstituted heterocyclic group is preferable. Among these groups, a substituted alkyl group, a substituted aryl group, and a substituted heterocyclic group are preferable, and particularly a substituted alkyl group is most preferable.

V₁ and V₂ may be the same or different, and each represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. A hydrogen atom, a substituted or unsubstituted alkyl group, a substituted or unsubstituted aryl group, and a substituted or unsubstituted heterocyclic group are preferable. Among these groups, a hydrogen atom, a substituted alkyl group, a substituted aryl group, and a substituted heterocyclic group are most preferable. Z, V₁, and V₂ each may further have a substituent.

As the substituted or unsubstituted alkyl groups represented by Z, V₁, and V₂, alkyl groups having 1 to 30 carbon atoms are preferable. In particular, branched alkyl groups are preferable because both dye solubility and ink stability are improved, and particularly alkyl groups having an asymmetric carbon atom (use in the form of a racemic body) are particularly preferable. Examples of a substituent include substituents that Formula (C) may have. In particular, a hydroxyl group, an ether group, an ester group, a cyano group, an amino group, an amide group, and a sulfonamide group are particularly preferable because association properties of a dye are increased and dye fastness is improved. In addition, the substituent may include a halogen atom or an ionic hydrophilic group.

As the substituted or unsubstituted cycloalkyl groups represented by Z, V₁, and V₂, cycloalkyl groups having 5 to 30 carbon atoms are preferable. In particular, cycloalkyl groups having an asymmetric carbon atom (use in the form of a racemic body) are particularly preferable because both dye solubility and ink stability are improved. Examples of a substituent include the substituents that Formula (C) may have. In particular, a hydroxyl group, an ether group, an ester group, a cyano group, an amino group, an amide group, and a sulfonamide group are particularly preferable because association properties of a dye are increased and dye fastness is improved. In addition, the substituent may include a halogen atom or an ionic hydrophilic group.

As the substituted or unsubstituted alkenyl groups represented by Z, V₁, and V₂, alkenyl groups having 2 to 30 carbon atoms are preferable. In particular, branched alkenyl groups are preferable because both dye solubility and ink stability are improved, and alkenyl groups having an asymmetric carbon atom (use in the form of a racemic body) are particularly preferable. Examples of a substituent include substituents that Formula (C) may have. In particular, a hydroxyl group, an ether group, an ester group, a cyano group, an amino group, an amide group, and a sulfonamide group are particularly preferable because association properties of a dye is increased and dye fastness is improved. In addition, the substituent may include a halogen atom or an ionic hydrophilic group.

As the substituted or unsubstituted alkynyl groups represented by Z, V₁, and V₂, alkynyl groups having 2 to 30 carbon atoms are preferable. In particular, branched alkynyl groups are preferable because both dye solubility and ink stability are improved, and particularly alkynyl groups having an asymmetric carbon atom (use in the form of a racemic body) are particularly preferable. Examples of a substituent include substituents that Formula (C) may have. In particular, a hydroxyl group, an ether group, an ester group, a cyano group, an amino group, an amide group, and a sulfonamide group are particularly preferable because association properties of a dye are increased and dye fastness is improved. In addition, the substituent may include a halogen atom or an ionic hydrophilic group.

As the substituted or unsubstituted aralkyl groups represented by Z, V₁, and V₂, aralkyl groups having 7 to 30 carbon atoms are preferable. In particular, a branched aralkyl groups are preferable because both dye solubility and ink stability are improved, and particularly aralkyl groups having an asymmetric carbon atom (use in the form of a racemic body) are particularly preferable. Examples of a substituent include substituents that Formula (C) may have. In particular, a hydroxyl group, an ether group, an ester group, a cyano group, an amino group, an amide group, and a sulfonamide group are particularly preferable because association properties of a dye are increased and dye fastness is improved. In addition, the substituent may include a halogen atom or an ionic hydrophilic group.

As the substituted or unsubstituted aryl groups represented by Z, V₁, and V₂, aryl groups having 6 to 30 carbon atoms are preferable. Examples of a substituent include substituents that Formula (C) may have. In particular, electron withdrawing groups are preferable because oxidation potential of a dye is made noble and dye fastness is improved.

It is preferable that the phthalocyanine dye used in the invention has an ionic hydrophilic group. Examples of the ionic hydrophilic group include a sulfo group, a carboxyl group, a phosphono group, and a quaternary ammonium group. As the ionic hydrophilic group, a carboxyl group, a phosphono group, and a sulfo group are preferable, and particularly a carboxyl group and a sulfo group are preferable. The carboxyl group, the phosphono group, and the sulfo group may be in the form of salt. Examples of a counter ion constituting the salt include ammonium ion, alkaline metal ions (e.g., lithium ion, sodium ion, and potassium ion), and organic cations (e.g., tetramethylammonium ion, tetramethylguanidinium ion, and tetramethylphosphonium ion). Among these counter ions, alkaline metal salts are preferable. In particular, lithium salts are particularly preferable because they enhance solubility of a dye and increase ink stability. The most preferable ionic hydrophilic group is a lithium salt of a sulfo group.

The number of ionic hydrophilic groups is preferably 2 or more per molecule of the phthalocyanine dye of the invention. In particular, the phthalocyanine dye having at least two of the group consisting of a sulfo group and a carboxyl group is particularly preferable.

Preferable examples of M include a hydrogen atom and a metal atom, such as Li, Na, K, Mg, Ti, Zr, V, Nb, Ta, Cr, Mo, W, Mn, Fe, Co, Ni, Ru, Rh, Pd, Os, Ir, Pt, Cu, Ag, Au, Zn, Cd, Hg, Al, Ga, In, Si, Ge, Sn, Pb, Sb, or Bi. Examples of oxides include VO and GeO. Examples of hydroxides include Si(OH)₂, Cr(OH)₂, and Sn(OH)₂. Examples of halides include AlCl, SiCl₂, VCl, VCl₂, VOCl, FeCl, GaCl, and ZrCl. Among these materials, Cu, Ni, Zn, Al, and the like are preferable, and Cu is most preferable.

Further, as the phthalocyanine dye used in the invention, a plurality of Pc (phthalocyanine ring) may form via L (divalent linking group) a dimmer (for example, Pc-M-L-M-Pc), or a trimmer. M's in the dimmer or trimmer may be the same or different from each other.

The divalent linking group represented by L is preferably an oxy group (—O—), a thio group (—S—), a carbonyl group (—CO—), a sulfonyl group (—SO₂—), an imino group (—NH—), a methylene group (—CH₂—), or a group that is formed by a combination of these groups.

With respect to the chemical structure of the phthalocyanine dye of the invention, it is particularly preferable that an electron-withdrawing group such as a sulfinyl group (—SO—Z), a sulfonyl group (—SO₂—Z), a sulfamoyl group (—SO₂NV₁V₂), a carbamoyl group (—CONV₁V₂), an alkoxycarbonyl group, an aryloxycarbonyl group, a heterocyclic oxycarbonyl group (—CO₂Z), an acyl group (—CO—Z), or a sulfo group be introduced into each benzene ring of the phthalocyanine of the invention so that the total substituent up value of the entire phthalocyanine skeleton is 1.2 or more.

Among these groups, a sulfinyl group (—SO—Z), a sulfonyl group (—SO₂Z), and a sulfamoyl group (—SO₂NV₁ V₂) are preferable. Further, a sulfonyl group (—SO₂Z) and a sulfamoyl group (—SO₂NV₁V₂) are more preferable, and a sulfonyl group (—SO₂Z) is most preferable.

The Hammett's substituent constant up value is briefly explained below. The Hammett's rule is an empirical rule that L. P. Hammett proposed in 1935 to quantitatively discuss the effects of substituents on the reaction or equilibrium of benzene derivatives, and the validity of this empirical rule has been widely accepted today.

Substituent constants determined by the Hammett's rule are σp value and σm value, and these values are found in many general literatures, and for the details of these values, reference can be made to J. A. Dean, “Lange's Handbook of Chemistry”, 12th ed., 1979 (Mc Graw-Hill), and “Kagaku no Ryoiki (Region of Chemistry)”, extra edition, No. 122, pp. 96-103, 1979 (Nankodo).

As a preferable combination of substituents of the compounds represented by Formula (C), compounds in which at least one of various substituents is one of the preferable substituents mentioned above are preferable. Further, compounds in which much more various substituents are the preferable substituents mentioned above are more preferable, and compounds in which all the substituents are the preferable substituents mentioned above are most preferable.

In the invention, the compound represented by Formula (C-1) that is used as a coloring material in a cyan ink is preferably a compound represented by the following Formula (C-2) or a salt thereof

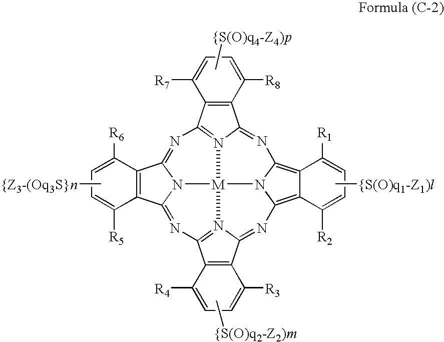

In Formula (C-2), R₁, R₂, R₃, R₄, R₅, R₆, R₇, and R₈ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryl oxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group. These groups may further have a substituent.

Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group. At least one of Z₁, Z₂, Z₃, or Z₄ has an ionic hydrophilic group as a substituent.

In Formula (C-2), l, m, n, p, q₁, q₂, q₃, and q₄ each independently represent an integer of 1 or 2.

M is the same as M in Formula (C).

In the invention, l, m, n, and p in Formula (C-2) each independently represent an integer of 1 or 2. In particular, it is preferable that two or more of l, m, n, and p be 1, and 1=m=n=p=1 is most preferable.

In Formula (C-2) above, q₁, q₂, q₃, and q₄ each independently represent an integer of 1 or 2. In particular, it is preferable that two or more of q₁, q₂, q₃, and q₄ be 2, and q₁=q₂=q₃=q₄=2 is most preferable.

In Formula (C-2), Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, and a substituted or unsubstituted alkyl group, a substituted or unsubstituted aryl group, and a substituted or unsubstituted heterocyclic group are preferable. Among these groups, a substituted alkyl group, a substituted aryl group, and a substituted heterocyclic group are preferable, and particularly a substituted alkyl group is most preferable. At least one of Z₁, Z₂, Z₃, or Z₄ must have an ionic hydrophilic group as a substituent.

In Formula (C-2), R₁, R₂, R₃, R₄, R₅, R₆, R₇, and R₈ each preferably represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, an ureido group, a sulfamoylamino group, an alkylthio group, arylthio group, an alkoxycarbonylamino group, a sulfonamido group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxycarbonyl group, an aryloxycarbonylamino group, an imido group, a heterocyclic thio group, a phosphoryl group, an acyl group, or an ionic hydrophilic group, more preferably a hydrogen atom, a halogen atom, an alkyl group, an aryl group, a heterocyclic group, a cyano group, a hydroxyl group, a nitro group, a carbamoyl group, a sulfamoyl group, a sulfinyl group, a sulfonyl group, an alkoxycarbonyl group, an aryloxycarbonyl group, a phosphoryl group, an acyl group, or an ionic hydrophilic group, further preferably a hydrogen atom, a halogen atom, a cyano group, a hydroxyl group, a sulfamoyl group, a sulfinyl group, a sulfonyl group, or an ionic hydrophilic group, and particularly most preferably a hydrogen atom.

In Formula (C-2), M is the same as M in Formula (C), and preferable examples are also the same.

As a preferable combination of substituents of the compound represented by Formula (C-2), compounds in which at least one of various substituents is one of the preferable substituents mentioned above are preferable, compounds in which much more various substituents are the preferable substituents mentioned above are more preferable, and compounds in which all the substituents are the preferable substituents mentioned above are most preferable.

The compound represented by Formula (C-2) that is used as a coloring material in a cyan ink in the invention is preferably a compound represented by the following Formula (C-3) and a salt thereof.

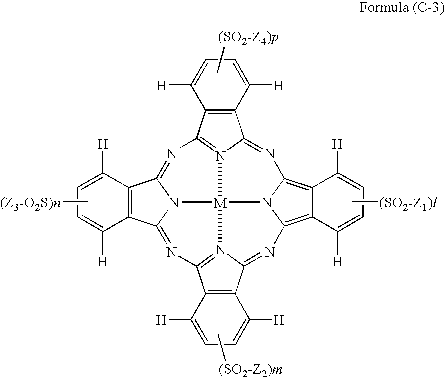

In Formula (C-3), Z₁, Z₂, Z₃, Z₄, l, m, n, p, and M are the same as Z₁, Z₂, Z₃, Z₄, l, m, n, p, and M, respectively in Formula (C-2).

In the invention, in Formula (C-3), l, m, n, and p each independently represent an integer of 1 or 2. In particular, it is preferable that two or more of l, m, n, and p be 1 and 1=m=n=p=1 is most preferable.

In Formula (C-3), Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group, and preferably a substituted or unsubstituted alkyl group, a substituted or unsubstituted aryl group, or a substituted or unsubstituted heterocyclic group. Among these groups, a substituted alkyl group, a substituted aryl group, and a substituted heterocyclic group are preferable, and particularly a substituted alkyl group is most preferable.

In more detail, Z₁, Z₂, Z₃, and Z₄ each independently represent Z₁₁ (where Z₁₁ represents —(CH₂)₃SO₃M₂ wherein M₂ represents an alkali metal atom) or Z₁₂ (where Z₁₂ represents —(CH₂)₃SO₂NHCH₂CH(OH)CH₃). In particular, a dye mixture in which the molar ratio of Z₁₁ to Z₁₂ (Z₁₁/Z₁₂) included in the entire cyan dye represented by Formula (C-3) above is 4/0, 3/1, 2/2, or 1/3 is preferable. Among these mixtures, a dye mixture having as a main component a dye in which a molar ratio of Z₁₁/Z₁₂ is 3/1, and a dye mixture having as a main component a dye in which a molar ratio of Z₁₁/Z₁₂ is 2/2 are most preferable. At least one of Z₁, Z₂, Z₃, or Z₄ must have an ionic hydrophilic group as a substituent.

In —(CH₂)₃SO₃M₂ represented by Z₁₁, M₂ is preferably an alkali metal atom. In particular, a lithium ion, a sodium ion, or a potassium ion is preferable and particularly a lithium ion is most preferable.

In Formula (C-3), M is the same as M in Formula (C-2) and preferable examples are also the same.

As a preferable combination of substituents of the compounds represented by Formula (C-3), compounds in which at least one of various substituents is one of the preferable substituents mentioned above are preferable, compounds in which much more various substituents are the preferable substituents mentioned above are more preferable, and compounds in which all the substituents are the preferable substituents mentioned above are most preferable.

In the invention, the content of a cyan dye contained in a cyan ink is determined depending on the type of X₁ to X₄ and Y₁ to Y₄ in Formula (C), the type of a solvent component and the like to be used for producing the ink composition. In the invention, the cyan dye represented by Formula (C) is contained in the cyan ink composition in a proportion of preferably from 1 to 10% by mass and more preferably from 2 to 6% by mass in total based on the total amount of the cyan ink.

By adjusting the total amount of the dyes of Formula (C) contained in the cyan ink so as to be 1% by mass or more, favorable coloring properties of ink on a recording medium when printed can be achieved and a required image density can be secured. By adjusting the total amount of the dyes of Formula (C) contained in the cyan ink so as to be 10% by mass or lower, it is possible to obtain, when used for an inkjet recording method, such advantages that favorable ejection properties of the cyan ink are achieved, and also clogging of an inkjet nozzle is prohibited.

The cyan ink used in the invention may contain a dye other than the water-soluble dye represented by Formula (C). However, the content of the water-soluble dye represented by Formula (C) is preferably 25% by mass or more, more preferably 50% by mass or more, and further preferably 60% by mass or more, respectively based on a total of dyes.

An inkjet recording method of the invention is a method of recording an image by applying at least one ink selected from the group consisting of the above-described magenta ink, the above-described black ink, the above-described yellow ink, and the above-described cyan ink, according to an inkjet process, on an inkjet recording medium. It is preferable to use each of the above-described inks in the form of ink sets each containing at least two inks from viewpoints of easily obtaining an image having a wide variety of hue.

As for the above-described ink set, a cyan ink having a relatively high color density (dark cyan ink) and a cyan ink having a relatively low color density (light cyan ink) can be contained as a cyan ink in the ink set.

When the dark cyan ink and the light cyan ink are incorporated in the ink set, it is preferable for at least one of the dark cyan ink and the light cyan ink to contain, as a colorant, at least one of the dyes of the above described Formulae (C), (C-2), and (C-3).

Among the two kinds of cyan inks having different color densities, the light cyan ink is preferably a mixture including at least one dye selected from the group consisting of a compound represented by Formula (C-2) and a salt thereof, in which Z₁, Z₂, Z₃, and Z₄ are each independently Z₁₁ (where Z₁₁ represents —(CH₂)₃SO₃M₂, where M₂ represents an alkali metal atom) or Z₁₂ (where Z₁₂ represents —(CH₂)₃SO₂NHCH₂CH(OH)CH₃). In particular, a dye mixture in which the molar ratio of Z₁₁ to Z₁₂ included in the entire cyan dye represented by Formula (C-3) is 4/0, 3/1, 2/2 or 1/3 is preferable. Among the above, a dye mixture having as a main component a dye in which a molar ratio of Z₁₁ to Z₁₂ is 2/2 is most preferable.

In addition, it is also preferable for the light cyan ink among the two kinds of the cyan inks having different color densities to contain at least one compound selected from the group consisting of a compound represented by the following Formula (C-4) and a salt thereof.

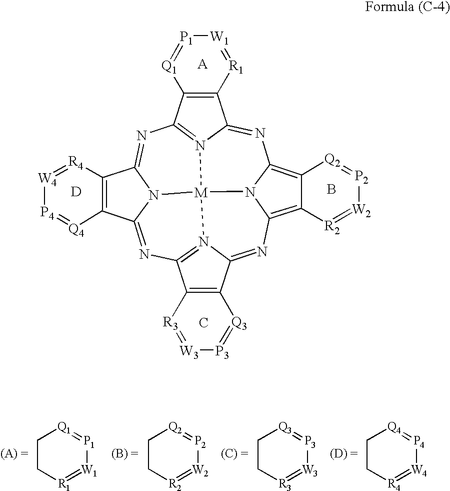

In Formula (C-4), Q₁ to Q₄, P₁ to P₄, W₁ to W₄, and R₁ to R₄ each independently represent (═C(J₁)- and/or —N═), (═C(J₂)- and/or —N═), (═C(J₃) and/or —N═), or (═C(J₄)- and/or —N═). J₁ to J₄ each independently represent a hydrogen atom and/or a substituent. At least one of ring (A), ring (B), ring (C) or ring (D) constituted by (Q₁, P₁, W₁, and R₁), (Q₂, P₂, W₂, R₂), (Q₃, P₃, W₃, R₃), and (Q₄, P₄, W₄, R₄) is a heterocyclic ring.

In more detail, in the cyan dye represented by Formula (C-4), among these ring (A), ring (B), ring (C) and ring (D) constituted by (Q₁, P₁, W₁, and R₁), (Q₂, P₂, W₂, R₂), (Q₃, P₃, W₃, R₃), and (Q₄, P₄, W₄, R₄), at least one heterocyclic ring is preferably a nitrogen-containing heterocyclic ring. In particular, the heterocyclic ring is preferably a pyridine ring, a pyrazine ring, a pyrimidine ring, or a pyridazine ring, more preferably a pyridine ring or a pyrazine ring, and particularly most preferably a pyridine ring.

More preferably, in the cyan dye represented by Formula (C-4), when these ring (A), ring (B), ring (C) and ring (D) constituted by (Q₁, P₁, W₁, and R₁), (Q₂, P₂, W₂, R₂), (Q₃, P₃, W₃, R₃), and (Q₄, P₄, W₄, R₄) represent aromatic rings, the aromatic ring represented by Formula (1) is preferable.

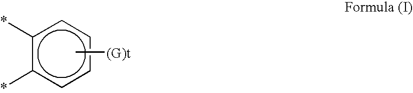

In Formula (1), * represents a connecting position with a phthalocyanine skeleton. In Formula (1), G represents —SO—Z₁, —SO₂—Z₁, —SO₂NZ₂Z₃, —CONZ₂Z₃, —CO₂Z₁, —COZ₁, or a sulfo group. In Formula (1), t represents an integer of 1 to 4.

Z₁s may be the same or different and represents a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

In Formula (I), examples of preferable Z₁ include a substituted or unsubstituted alkyl group, a substituted or unsubstituted aryl group, and a substituted or unsubstituted heterocyclic group. Among the above, a substituted alkyl group and a substituted aryl group are preferable and particularly a substituted alkyl group is most preferable.

Z₂ and Z₃ may be the same or different, and represent a hydrogen atom, a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group.

In Formula (I), examples of preferable Z₂ and Z₃ each independently represent a hydrogen atom, a substituted or unsubstituted alkyl group, a substituted or unsubstituted aryl group, and a substituted or unsubstituted heterocyclic group. Among the above, a hydrogen atom, a substituted alkyl group, and a substituted aryl group are preferable. In particular, it is most preferable that one of Z₂ and Z₃ represents a hydrogen atom and another one represents a substituted alkyl group or a substituted aryl group.

In Formula (I), examples of preferable G include —SO—Z₁, —SO₂—Z₁, —SO₂NZ₂Z₃, —CONZ₂Z₃, —CO₂Z₁, and —COZ₁. Among these groups, —SO—Z₁, —SO₂—Z₁, and —SO₂NZ₂Z₃ are preferable, and particularly —SO₂—Z₁ is most preferable.

In Formula (I), t preferably represents an integer of 1 to 3, and more preferably an integer of 1 to 2, and t=1 is most preferable.

In more detail, when any of the A ring, B ring, C ring, and D ring is an aromatic ring in the cyan dye represented by Formula (C-4), it is preferable that at least one aromatic ring be represented by Formula (II).

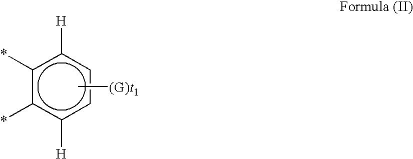

In Formula (II), * represents a connecting position with a phthalocyanine skeleton.

In Formula (II), G is the same as G in Formula (I), and preferable examples are also the same as those of G in Formula (1).

In Formula (II), t₁ is 1 or 2 and particularly t₁=1 is preferable.

Specific preferable examples of the dye represented by Formula (C) include compounds described in paragraphs [0582] to [0652] of JP-A-No. 2007-138124.

The ink used in the invention contains at least one of water-soluble dyes represented by the above-described Formulae (M), (BK), (Y) and (C), and further, if necessary, may contain a water-based medium or other additives in such an amount that these materials do not adversely affect effects of the invention. Examples of the other additives include known additives, such as boron compounds, dry inhibitors (wetting agents), fading inhibitors, emulsion stabilizers, penetration accelerators, UV absorbers, antiseptic agents, antifungal agents, pH adjustors, surface tension adjusters, defoaming agents, viscosity controlling agents, dispersing agents, dispersion stabilizers, antirust agents, and chelating agents.

The water-based medium contains water as a component. If desired, a mixture of water and a water-miscible organic solvent may be used. Examples of the water-miscible organic solvents include alcohols (e.g., methanol, ethanol, propanol, isopropanol, butanol, isobutanol, sec-butanol, t-butanol, pentanol, hexanol, cyclohexanol, and benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerol, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, a dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethyl propylenediamine), and other polar solvents (e.g., formamide, N,N-dimethylformamide, N,N-dimethylacetamide, dimethyl sulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). The water miscible organic solvents may be used in combination of two or more thereof.

The dry inhibitor is suitably used for the purpose of preventing clogging caused by dryness of ink in an ink ejection opening of a nozzle for use in an inkjet recording method.

As the dry inhibitors, water soluble organic solvents having a vapor pressure lower than that of water are preferable. Specific examples of the dry inhibitor include polyhydric alcohols, such as ethylene glycol, propylene glycol, diethylene glycol, polyethylene glycol, thiodiglycol, dithio diglycol, 2-methyl-1,3-propanediol, 1,2,6-hexanetriol, acetylene glycol derivatives, glycerol, or trimethylolpropane; lower alkyl ethers of polyhydric alcohols, such as ethylene glycol monomethyl (or ethyl)ether, diethylene glycol monomethyl (or ethyl)ether, or triethylene glycol monoethyl (or butyl)ether; heterocycles, such as 2-pyrrolidone, N-methyl-2-pyrrolidone, 1,3-dimethyl-2-imidazolidinone, or N-ethylmorpholine; sulphur-containing compounds, such as sulfolane, dimethyl sulfoxide, or 3-sulfolene; polyfunctional compounds, such as diacetone alcohol or diethanolamine; and urea derivatives. Among these compounds, polyhydric alcohols, such as glycerol or diethylene glycol, are more preferable. The dry inhibitors mentioned above may be used singly or in combination of two or more kinds thereof. It is preferable that the dry inhibitor be contained in ink in a proportion of 10 to 50% by mass.

The penetration accelerator is suitably used for the purpose of penetrating more effectively inkjet ink into a paper. Examples of the penetration accelerator include alcohols, such as ethanol, isopropanol, butanol, di(tri) ethylene glycol monobutyl ether, or 1,2-hexanediol and nonionic surfactants, such as sodium lauryl sulfate or sodium oleate. The penetration accelerators generally exhibit sufficient effects when contained in ink in a proportion of 5 to 30% by mass. It is preferable to use the penetration accelerator with such an addition amount that neither printing bleeding nor print through is caused.

The UV absorbers are used for the purpose of improving storability of images. Examples of the UV absorber include benzotriazole compounds mentioned in JP-A Nos. 58-185677, 61-190537, 2-782, 5-197075, and 9-34057, benzophenone compounds mentioned in JP-A Nos. 46-2784 and 5-194483 and U.S. Pat. No. 3,214,463, cinnamic acid compounds mentioned in JP-B Nos. 48-30492, 56-21141, and JP-A No 10-88106, triazine compounds mentioned in JP-A Nos. 4-298503, 8-53427, 8-239368, and 10-182621 and Japanese Application National phase Publication No. 8-501291, compounds mentioned in Research Disclosure No. 24239, and compounds, which absorb ultraviolet rays to emit fluorescence, typified by stilbene- or benzoxazole-based compounds, i.e., a so-called fluorescent brightening agent.

The fading inhibitors are used for the purpose of increasing storability of images. Examples of the fading inhibitors include various organic fading inhibitors and metal complex fading inhibitors. Examples of the organic fading inhibitor include hydroquinones, alkoxy phenols, dialkoxy phenols, phenols, anilines, amines, indans, chromans, alkoxy anilines, thioethers, thioureas (examples of the thioethers and thioureas are described in JP-A No. 2002-36717, and examples of thioethers are described in JP-A No. 2002-86904), and heterocycles. Examples of the metal complex fading inhibitor include nickel complexes and zinc complexes. More specifically, examples include compounds mentioned in patents cited in Research Disclosure Nos. 17643, VII-I or J, 15162, 18716, p. 650, left column, 36544, p. 527, 307105 p. 872, and 15162 or typically exemplified compounds and compounds represented by Formulae mentioned in JP-A No. 62-215272, pp. 127 to 137.

Examples of the antifungal agents include sodium dehydroacetate, sodium benzoate, sodium pyridinethione-1-oxide, ethyl-p-hydroxybenzoate ester, 1,2-benzisothiazoline-3-one, and salts thereof. It is preferable that the antifungal agents be contained in ink in a proportion of 0.02 to 1.00% by mass.

Examples of the pH adjustors include neutralizers (organic bases and inorganic alkalis). The pH adjustors are added for the purpose of increasing storage stability of inkjet ink so that the pH of the inkjet ink is preferably 6 to 10 and more preferably 7 to 10.

Examples of the surface tension adjustors include nonionic surfactants, cationic surfactants, and anionic surfactants. The surface tension of the inkjet ink in the invention is preferably from 25 to 70 mN/m, and more preferably from 25 to 60 mN/m. The viscosity of the inkjet ink in the invention is adjusted to preferably 30 mPa·s or less, and more preferably 20 mPa·s or less.

Preferable examples of the surfactant include anionic surfactants, such as fatty acid salts, alkyl sulfate salts, alkylbenzene sulfonic acid salts, alkylnaphthalenesulfonic acid salts, dialkyl sulfosuccinic acid salts, alkyl phosphate salts, naphthalenesulfonic acid formalin condensates, or polyoxyethylene alkyl sulfate salts and nonionic surfactants, such as polyoxyethylene alkyl ethers, polyoxyethylene alkyl aryl ethers, polyoxyethylene fatty acid esters, sorbitan fatty acid esters, polyoxyethylene sorbitan fatty acid esters, polyoxyethylene alkylamines, glycerol fatty acid esters, or oxyethylene oxypropylene block copolymers. Moreover, various types of Surfynol (product of Air Products & Chemicals) that are acetylene polyoxy ethylene oxide surfactants are also preferably used. Moreover, for example, amine oxide amphoteric surfactants, such as N,N-dimethyl-N-alkylamine oxide, and quaternary ammonium salt-containing betain type amphoteric surfactants such as N,N-dimethyl-N-lauryl-carboxymethylammonium are preferable. The substances mentioned as surfactants in JP-A No. 59-157, 636, pp. 37 to 38 and Research Disclosure No. 308119 (1989) can be also used.

As the defoaming agents, chelating agents typified by fluorine compounds, silicone compounds, or EDTA can be also used as required.

A preparation method of the ink used in the invention is not limited in particular. Details of the preparation method are described in, for example, JP-A Nos. 5-148436, 5-295312, 7-97541, 7-82515, 7-118584 and 2004-331871. These methods may be applied also to the preparation method of the ink used in the invention.

An inkjet process for recording an image on the inkjet recording medium in the invention is not limited in particular. Known system may be used such as a charge control system of ejecting inks by making use of electrostatic induction, a drop-on-demand system making use of vibration pressure of a piezo element (a pressure pulse system), an acoustic inkjet system of changing electric signal to acoustic beam, irradiating ink with the resultant acoustic beam and ejecting the ink by making use of radiation pressure, and a thermal ink jet system of heating ink to form bubbles and utilizing generated pressure. The inkjet recording system includes a method of ejecting low density ink, what is called photo-ink, in a small volume and in many colors, a method of improving images by using a plurality of inks substantially the same in hue and different in density, and a method of using colorless transparent ink.

### EXAMPLES

The present invent is described more specifically with reference to examples, but the scope of the invention is by no means restricted to the following specific examples. In the examples “parts” and “%” are based on mass unless otherwise indicated.

### Test Example 1

### Production of Support

50 parts of an LBKP formed from acacia and 50 parts of an LBKP formed from aspen were respectively beaten in 300 ml of Canadian Freeness with a disk refiner, to produce pulp slurries. Subsequently, to each of the resulting pulp slurries, 1.3% by mass of cationic starch (trade name: CATO 304L, manufactured by Nippon NSC, Ltd.), 0.15% by mass of anionic polyacrylamide (trade name: POLYAKRON ST-13, manufactured by Seiko PMC Corporation), 0.29% by mass of an alkylketene dimer (trade name: SIZEPINE K, manufactured by Arakawa Chemical Industries, Ltd.), 0.29% by mass of an epoxidated behenic acid amide, and 0.32% by mass of polyamide polyamine epichlorohydrin (trade name: ARAFIX 100, manufactured by Arakawa Chemical Industries, Ltd.) were added, all proportions being relative to the amount of pulp, and 0.12% by mass of an antifoaming agent was further added.

Base paper was produced by making paper from each of these pulp slurries using a Fourdrinier paper machine, pressing the felt surface of the web against a drum dryer cylinder through a dryer canvas, and drying the resultant, with the tensile force of the dryer canvas set at 1.6 kg/cm. Subsequently, 1 g/m² of polyvinyl alcohol (trade name: KL-118, manufactured by Kuraray Co., Ltd.) was coated on both sides of the base paper using a size press and dried, and then a calendar treatment were carried out to obtain a substrate paper. The basis weight of the obtained substrate paper was 166 g/m², and the thickness was 160 μm.

The wire surface (rear surface) of the obtained substrate paper was subjected to a corona discharge treatment, and then high density polyethylene was laminated thereon so as to be a thickness of 25 μm by using a melt extruder to form a thermoplastic resin layer having a matt surface (hereinafter, this thermoplastic resin layer surface is referred to as a “rear surface”). This rear surface was subjected again to a corona discharge treatment, and then a dispersion, in which aluminum oxide (trade name: “ALUMINASOL 100”, manufactured by Nissan Chemical Industries, Ltd.) and silicon dioxide (trade name: “SNOWTEX O” manufactured by Nissan Chemical Industries, Ltd.) were dispersed in water as antistatic agents at a mass ratio of 1:2, was applied on the surface to obtain a dried mass of 0.2 g/m².

Furthermore, the felt surface (front surface) on the side at which a thermoplastic resin layer was not provided, was subjected to a corona discharge treatment, and then a low density polyethylene having a melt flow rate (MFR) of 3.8, which had been prepared so as to contain 10% by mass of anatase titanium dioxide, 0.3% by mass of ultramarine blue (manufactured by Tokyo Printing Ink Manufacturing Co., Ltd.) and 0.08% by mass of a fluorescent brightener (trade name: “WHITEFLOUR PSN CONC”, manufactured by Nippon Chemical Industrial Co., Ltd.), was extruded on the surface so as to be a thickness of 25 μm using a melt extruder, to form a high gloss thermoplastic resin layer (hereinafter, this high gloss surface is referred to as a “front surface”). Thus, a water resistant support was produced. The outer shape of the water resistant support was formed to provide a long roll having a width of 1.5 m and a roll length of 3000 m.

Preparation of Undercoat Layer-Forming Liquid A

From the composition shown below, (1) deionized, alkali-treated gelatin, (2) ion-exchanged water, (3) magnesium chloride, and (4) methanol were mixed, and the mixture was dispersed using an ultrasonic dispersing machine (manufactured by SMT Corporation), thereby to prepare an undercoat layer-forming liquid A.

| | |
|---|---|
| (1) Deionized, alkali-treated gelatin (isoelectric point: 5.0) | 50.0 parts |
| (2) Ion-exchanged water | 250.0 parts |
| (3) Magnesium chloride | 30 parts |
| (4) Methanol | 670.0 parts |

Preparation of Ink Receiving Layer-Coating Liquid A1

From the composition shown below, (1) gas phase process silica fine particles, (2) ion-exchanged water, and (3) SHALLOL DC-902P were mixed, and the mixture was dispersed with an ultrasonic dispersing machine (manufactured by SMT Corporation). Subsequently, the resultant dispersion was heated to 45° C. and maintained for 20 hours. Thereafter, (4) boric acid, (5) a 7 mass % aqueous solution of an acetoacetyl-modified polyvinyl alcohol, and (6) a 10 mass % aqueous solution of a surfactant from the composition shown below, were added at 30° C. to prepare an ink receiving layer-coating liquid A1 (solution A).

Composition of Ink Receiving Layer-Coating Liquid A1

| | |
|---|---|
| (1) Gas phase process silica fine particles (inorganic | 10.0 parts |
| fine particles) (trade name: AEROSIL 300SV, manufactured | |
| by Nippon Aerosil Co., Ltd.) | |
| (2) Ion-exchanged water | 56 parts |
| (3) “SHALLOL DC-902P” (51.5% aqueous solution) | 0.8 parts |
| (dispersant, manufactured by Dai-ichi Kogyo Seiyaku Co., | |
| Ltd.) | |
| (4) Boric acid (crosslinking agent) | 0.37 parts |
| (5) 7% aqueous solution of acetoacetyl-modified polyvinyl | 29 parts |
| alcohol (trade name: Z210, manufactured by Nippon Synthetic | |
| Chemical Industry Co., Ltd.) | |
| (6) 10% aqueous solution of surfactant (trade name: | 0.6 parts |
| EMULGEN 109P, manufactured by Kao Corporation) | |

Preparation of Crosslinking Agent Solution 1

The components of the following composition were dissolved and mixed at normal temperature to prepare a crosslinking agent solution 1 (curing solution).

| | |
|---|---|
| (1) Ion-exchanged water | 30 parts |
| (2) Adipic acid dihydrazide (water-soluble multifunctional | 1 part |
| crosslinking agent) | |
| (3) 10% aqueous solution of surfactant (trade name: | 0.5 parts |
| EMULGEN, manufactured by Kao Corporation) | |

Production of Inkjet Recording Medium

The front surface of the support obtained as described above was subjected to a corona discharge treatment, and then 10 ml/m² of the aforementioned undercoat layer-forming liquid A was coated thereon using a wire bar, and was dried at 70° C. for 2 minutes to form an undercoat layer (solid content coating amount: 0.8 g/m²).

Subsequently, the ink-receiving layer-coating liquid A1 was applied with a slide bead coater so as to be a coating amount of 200 ml/m², and was dried by a hot air dryer at 80° C. (air speed 3 msec) for 3 minutes (solid content coating amount: 28.2 g/m²). During this period, the coating film exhibited constant-rate drying. Immediately after the drying for 3 minutes, this coating film was immersed in the crosslinking agent solution 1 for 1 second, and was dried at 80° C. for 10 minutes (solid content coating amount: 0.3 g/m²). Thereby, an inkjet recording medium (1) was produced.

### Test Example 2

An inkjet recording medium (2) was produced in the same manner as in Test Example 1, except that the ink receiving layer-coating liquid A1 for forming a lower layer according to Test Example 1 was replaced with an inkjet-receiving layer-coating liquid A2 having the following composition.

Composition of Ink Receiving Layer-Coating Liquid A2

| | | |
|---|---|---|
| (1) Gas phase process silica fine particles | 10.0 | parts |
| (inorganic fine particles) (trade name: AEROSIL | | |
| 300SV, manufactured by Nippon Aerosil Co., Ltd.) | | |
| (2) Ion-exchanged water | 56 | parts |
| (3) SHALLOL DC-902P (51.5% aqueous solution) | 0.78 | parts |
| (dispersant, manufactured by Dai-ichi Kogyo | | |
| Seiyaku Co., Ltd.) | | |
| (4) Boric acid (crosslinking agent) | 0.37 | parts |
| (5) 7% aqueous solution of acetoacetyl-modified | 29 | parts |
| polyvinyl alcohol (trade name: Z210, manufactured | | |
| by Nippon Synthetic Chemical Industry Co., Ltd.) | | |
| (6) 10% aqueous solution of hydroxypropylcellulose | 3 | parts |
| (trade name: NISSO HPC-SSL, manufactured by Nippon | | |
| Soda Co., Ltd.; water-soluble cellulose derivative) | | |
| (7) 10% aqueous solution of surfactant (trade name: | 0.6 | parts |
| EMULGEN 109P, manufactured by Kao Corporation) | | |

### Test Example 3

An inkjet recording medium (3) was produced in the same manner as in Test Example 1, except that the ink receiving layer-coating liquid A1 for forming a lower layer according to Test Example 1 was replaced with an inkjet-receiving layer-coating liquid A3 having the following composition.

Composition of ink receiving layer-coating liquid A3

| | | |
|---|---|---|
| (1) Gas phase process silica fine particles | 10.0 | parts |
| (inorganic fine particles) (trade name: AEROSIL | | |
| 300SV, manufactured by Nippon Aerosil Co., Ltd.) | | |
| (2) Ion-exchanged water | 56 | parts |
| (3) SHALLOL DC-902P (51.5% aqueous solution) | 0.78 | parts |
| (dispersant, manufactured by Dai-ichi Kogyo | | |
| Seiyaku Co., Ltd.) | | |
| (4) Boric acid (crosslinking agent) | 0.37 | parts |
| (5) 7% aqueous solution of acetoacetyl-modified | 29 | parts |
| polyvinyl alcohol (trade name: Z210, manufactured | | |
| by Nippon Synthetic Chemical Industry Co., Ltd.) | | |
| (6) 10% aqueous solution of hydroxypropylcellulose | 3 | parts |
| (trade name: NISSO HPC-SSL, manufactured by Nippon | | |
| Soda Co., Ltd.; water-soluble cellulose derivative) | | |
| (7) Poly aluminum chloride (trade name: ALUFINE | 1.5 | parts |
| 83, manufactured by Taimei Chemicals Co., Ltd. | | |
| (8) 10% aqueous solution of surfactant (trade name: | 0.6 | parts |
| EMULGEN 109P, manufactured by Kao Corporation) | | |

### Test Example 4

### Preparation of Ink Receiving Layer-Coating Liquid A3

An ink receiving layer-coating liquid A3 (first solution) having the same compositions as those of Test Example 3 was prepared.

Preparation of Ink Receiving Layer-Coating Liquid B1

An ink-receiving layer-coating liquid B1 (second solution) was prepared in the same manner as the ink-receiving layer-coating liquid A1 according to Test Example 1, except that the composition of the ink receiving layer-coating liquid A1 was changed as follows.

Composition of Ink Receiving Layer-Coating Liquid B1

| | | |
|---|---|---|
| (1) Gas phase process silica fine particles | 10.0 | parts |
| (inorganic fine particles) (trade name: AEROSIL | | |
| 300SV, manufactured by Nippon Aerosil Co., Ltd.) | | |
| (2) Ion-exchanged water | 56 | parts |
| (3) SHALLOL DC-902P (51.5% aqueous solution) | 0.78 | parts |
| (dispersant, manufactured by Dai-ichi Kogyo | | |
| Seiyaku Co., Ltd.) | | |
| (4) Boric acid (crosslinking agent) | 0.37 | parts |
| (5) 7% aqueous solution of polyvinyl alcohol | 29 | parts |
| (trade name: PVA-235, manufactured by Kuraray | | |
| Co., Ltd.) | | |
| (6) Poly aluminum chloride (trade name: ALUFINE | 1.5 | parts |
| 83, manufactured by Taimei Chemicals Co., Ltd. | | |
| (7) 10% aqueous solution of surfactant (trade | 0.6 | parts |
| name: EMULGEN 109P, manufactured by Kao | | |
| Corporation) | | |

Production of Inkjet Recording Medium

The front surface of the support having thereon the undercoat layer obtained as described above was subjected to a corona discharge treatment.

Subsequently, the ink-receiving layer-coating liquid A3 as an under layer and the ink-receiving layer-coating liquid B1 as an upper layer were multilayer-coated with a slide bead coater so as to be coating amounts of 160 ml/m² and 40 ml/m², respectively. Thus, in the following order, a first coating film of the ink-receiving layer-coating liquid A3 and a second coating film of the ink-receiving layer-coating liquid B1 were formed on the support, and were dried by a hot air dryer at 80° C. (air speed 3 msec) for 3 minutes. During this period, the first coating film and the second coating film exhibited constant-rate drying. Immediately after the drying for 3 minutes, this coating film was immersed in the crosslinking agent solution 1 for 1 second, and was dried at 80° C. for 10 minutes. Thereby, an inkjet recording medium (4) was produced.

### Test Example 5

### Preparation of Ink Receiving Layer-Coating Liquid A3

An ink receiving layer-coating liquid A3 (first solution) having the same compositions as those of Test Example 3 was prepared.

Preparation of Ink Receiving Layer-Coating Liquid C1

An ink-receiving layer-coating liquid C1 (second solution) was prepared in the same manner as the ink-receiving layer-coating liquid A1 according to Test Example 1, except that the composition of the ink receiving layer-coating liquid A1 was changed as follows.

Composition of Ink Receiving Layer-Coating Liquid C1

| | |
|---|---|
| (1) Gas phase process silica fine particles | 10.0 parts |
| (inorganic fine particles) (trade name: AEROSIL | |
| 300SV, manufactured by Nippon Aerosil Co., Ltd.) | |
| (2) Ion-exchanged water | 56 parts |
| (3) SHALLOL DC-902P (51.5% aqueous solution) | 0.78 parts |
| (dispersant, manufactured by Dai-ichi Kogyo | |
| Seiyaku Co., Ltd.) | |
| (4) Boric acid (crosslinking agent) | 0.37 parts |
| (5) 7% aqueous solution of polyvinyl alcohol | 29 parts |
| (trade name: PVA-235, manufactured by | |
| Kuraray Co., Ltd.) | |
| (6) 10% aqueous solution of surfactant (trade name: | 0.6 parts |
| EMULGEN 109P, manufactured by Kao Corporation) | |

### Preparation of Ink Receiving Layer-Coating Liquid B2

An ink-receiving layer-coating liquid B2 (curing solution) was prepared in the same manner as the ink-receiving layer-coating liquid A1 according to Test Example 1, except that the composition of the ink receiving layer-coating liquid A1 was changed as follows.

Composition of ink receiving layer-coating liquid B2

| | | |
|---|---|---|
| (1) Gas phase process silica fine particles | 10.0 | parts |
| (inorganic fine particles) (trade name: AEROSIL | | |
| 300SV, manufactured by Nippon Aerosil Co., Ltd.) | | |
| (2) Ion-exchanged water | 56 | parts |
| (3) SHALLOL DC-902P (51.5% aqueous solution) | 0.78 | parts |
| (dispersant, manufactured by Dai-ichi Kogyo | | |
| Seiyaku Co., Ltd.) | | |
| (4) Boric acid (crosslinking agent) | 0.37 | parts |
| (5) 7% aqueous solution of polyvinyl alcohol | 29 | parts |
| (trade name: PVA-235, manufactured by Kuraray Co., Ltd.) | | |
| (6) Adipic acid dihydrazide | 1 | part |
| (7) 10% aqueous solution of surfactant (trade name: | 0.6 | parts |
| EMULGEN 109P, manufactured by Kao Corporation) | | |

Production of Inkjet Recording Medium

The front surface of the support having thereon the undercoat layer obtained as described above was subjected to a corona discharge treatment.

Subsequently, the ink-receiving layer-coating liquid A3 as an undermost layer, the ink-receiving layer-coating liquid C1 as an intermediate layer and the ink-receiving layer-coating liquid B2 as an uppermost layer were simultaneously multilayer-coated with a slide bead coater so as to be coating amounts of 140 ml/m², 40 ml/m² and 40 ml/m², respectively. Thus, in the following order, a first coating film of the ink-receiving layer-coating liquid A3, a second coating film of the ink-receiving layer-coating liquid C1 and a third coating film of the ink-receiving layer-coating liquid B2 were formed on the support and dried by a hot air dryer at 80° C. (air speed 3 msec) for 10 minutes. Thereby, an inkjet recording medium (5) was produced.

### Test Example 6

An inkjet recording medium (6) was produced in the same manner as in Test Example 5, except that the ink receiving layer-coating liquid B2 for forming an uppermost layer according to Test Example 5 was replaced with an inkjet-receiving layer-coating liquid B3 having the following composition.

Composition of Ink Receiving Layer-Coating Liquid B3

| | | |
|---|---|---|
| (1) Gas phase process silica fine particles | 10.0 | parts |
| (inorganic fine particles) (trade name: AEROSIL | | |
| 300SV, manufactured by Nippon Aerosil Co., Ltd.) | | |
| (2) Ion-exchanged water | 56 | parts |
| (3) SHALLOL DC-902P (51.5% aqueous solution) | 0.78 | parts |
| (dispersant, manufactured by Dai-ichi Kogyo | | |
| Seiyaku Co., Ltd.) | | |
| (4) Boric acid (crosslinking agent) | 0.37 | parts |
| (5) 7% aqueous solution of polyvinyl alcohol | 29 | parts |
| (trade name: PVA-235, manufactured by Kuraray Co., Ltd.) | | |
| (6) 10% aqueous solution of hydroxypropylcellulose | 3 | parts |
| (trade name: NISSO HPC-SSL, manufactured by Nippon | | |
| Soda Co., Ltd.; water-soluble cellulose derivative) | | |
| (7) Poly aluminum chloride (trade name: ALUFINE | 1.5 | parts |
| 83, manufactured by Taimei Chemicals Co., Ltd. | | |
| (8) 10% aqueous solution of surfactant (trade name: | 0.6 | parts |
| EMULGEN 109P, manufactured by Kao Corporation) | | |
| (9) Adipic acid dihydrazide | 1 | part |

### Test Example 7

An inkjet recording medium (7) was produced in the same manner as in Test Example 5, except that the ink receiving layer-coating liquid A3 for forming an under layer according to Test Example 5 was replaced with the above-described inkjet-receiving layer-coating liquid A1 (first solution).

### Test Example 8

The front surface of the support having thereon the undercoat layer obtained as described above was subjected to a corona discharge treatment.

Subsequently, coating was performed in the same manner as in Test Example 5, except that the ink-receiving layer-coating liquid A3 as an under layer and the ink-receiving layer-coating liquid B2 as an upper layer were multilayer-coated with a slide bead coater so as to be coating amounts of 160 ml/m² and 40 ml/m², respectively without coating the ink-receiving layer-coating liquid C1. Thus, in the following order, a coating film of the ink-receiving layer-coating liquid A3 and a curing coating film of the ink-receiving layer-coating liquid B2 were formed on the support, and were dried by a hot air dryer at 80° C. (air speed 3 msec) for 3 minutes. Thereby, an inkjet recording medium (8) was produced.

### Test Example 9

### Preparation of Undercoat Layer-Forming Liquid B

From the composition shown below, (1) deionized, alkali-treated gelatin, (2) ion-exchanged water and (3) methanol were mixed, and the mixture was dispersed using an ultrasonic dispersing machine (manufactured by SMT Corporation) to prepare an undercoat layer-forming liquid B.

| | |
|---|---|
| (1) Deionized, alkali-treated gelatin (isoelectric point: 5.0) | 50.0 parts |
| (2) Ion-exchanged water | 280.0 parts |
| (3) Methanol | 670.0 parts |

Production of Inkjet Recording Medium

The front surface of the support obtained as described above was subjected to a corona discharge treatment.

Subsequently, the above-described undercoat layer-forming liquid B was coated with a wire bar so as to be a coating amount of 10 ml/m² on the front surface of the support, and was dried at 70° C. for 2 minutes to form an undercoat layer.

An inkjet recording medium (9) was produced in the same manner as in Test Example 4, except that the above-described support was used as a support having thereon an undercoat layer.

### Test Example 10

### Preparation of Ink Receiving Layer-Coating Liquid A4

An ink receiving layer-coating liquid A 4 was prepared in the same manner as the ink receiving layer-coating liquid A1 according to Test Example 1, except that the composition of the ink receiving layer-coating liquid A1 was changed as follows.

Composition of Ink Receiving Layer-Coating Liquid A4

| | | |
|---|---|---|
| (1) Gas phase process silica fine particles | 10.0 | parts |
| (inorganic fine particles) (trade name: AEROSIL | | |
| 300SV, manufactured by Nippon Aerosil Co., Ltd.) | | |
| (2) Ion-exchanged water | 56 | parts |
| (3) SHALLOL DC-902P (51.5% aqueous solution) | 0.8 | parts |
| (dispersant, manufactured by Dai-ichi Kogyo | | |
| Seiyaku Co., Ltd.) | | |
| (4) Boric acid (crosslinking agent) | 0.37 | parts |
| (5) 7% aqueous solution of acetoacetyl-modified | 29 | parts |
| polyvinyl alcohol (trade name: Z210, manufactured | | |
| by Nippon Synthetic Chemical Industry Co., Ltd.) | | |
| (6) Poly aluminum chloride (trade name: ALUFINE | 1.5 | parts |
| 83, manufactured by Taimei Chemicals Co., Ltd. | | |
| (7) Magnesium chloride | 0.15 | parts |
| (8) 10% aqueous solution of surfactant (trade | 0.6 | parts |
| name: EMULGEN 109P, manufactured by Kao | | |
| Corporation) | | |

The front surface of the support having thereon the undercoat layer obtained in Test Example 9 was subjected to a corona discharge treatment.

Subsequently, the above-described ink receiving layer-forming liquid A4 was coated so as to be a coating amount of 200 ml/m² on the front surface of the support, and was dried at 80° C. (air speed 3 msec) for 10 minutes to produce an inkjet recording medium (10).

Evaluation

A respective sample of the inkjet recording media (1) to (10) obtained in the above-described Test Examples 1 to 10 was subjected to the following evaluations and measurements. The results of the measurements and evaluations are shown in the following Table 1.

Moisture Resistance (Bleeding)

A lattice-shaped pattern in which magenta and black portions are formed adjacent (length of a side of each inner square is 0.28 mm) was printed to form a 3 cm square image on the respective inkjet recording media using an inkjet printer (trade name: MP970, manufactured by Canon, Inc.) in ambient conditions of 23° C. and 50% RH. Immediately after the printing, the inkjet recording media were transferred to ambient conditions at 23° C. and 90% RH, and were left to stand for 7 days. After 7 days, the inkjet recording media were sufficiently dried under ambient conditions of 23° C. and 50% RH, and then the degree of bleeding was evaluated by visual inspection. The inkjet recording media were ranked according to the following evaluation criteria.

—Evaluation Criteria—

A: Bleeding was not observed.

B: Slight bleeding was observed.

C: Bleeding was significant and not practically acceptable.

Ozone Resistance

Solid images of magenta and cyan were respectively printed on each sheet for inkjet recording at a reflection density of 1.0±0.1, using an inkjet printer (trade name: “PM-G820”, manufactured by Seiko Epson Corporation), and the printed images were stored for 48 hours in an environment at an ozone concentration of 5 ppm. The magenta and cyan densities before storage and after storage were measured with a reflection densitometer (trade name: “X-RITE 938”, manufactured by X-Rite Inc.), and the residual rate of the magenta and cyan densities were calculated.

—Evaluation Criteria—
A: The lower value of the respective residual rates of magenta and cyan was 85% or greater.
B: The lower value of the respective residual rates of magenta and cyan was from 75% to less than 85%.
C: The lower value of the respective residual rates of magenta and cyan was from 65% to less than 75%.
D: The lower value of the respective residual rates of magenta and cyan was less than 65%.

Density

A black solid image was printed on each inkjet recording medium in an environment of 23° C. and 50% RH, using an inkjet printer (trade name: A820, manufactured by Seiko Epson Corporation). After printing, the images were left to stand overnight in the environment of 23° C. and 50% RH, and the visual reflection density was measured with a densitometer (trade name: X-RITE 310TR).

—Evaluation Criteria—

A: The density was 2.4 or greater.

B: The density was 2.3 or greater but less than 2.4.

C: The density was 2.2 or greater but less than 2.3.

D: The density was less than 2.2.

Coating Liquid Stability

The ink receiving layer-coating liquids A1 to A4 and B1 to B3 were respectively left to stand in ambient conditions of 30° C., and from the time at which the viscosity increased with time to reach 300 mPs or higher, the coating liquids were evaluated according to the following evaluation criteria.

—Evaluation Criteria—
A: Although the coating liquid was left to stand overnight after the preparation of the ink receiving layer-coating liquid, there were no problems in handling.
B: If standing time was within one hour after the preparation of the ink receiving layer-coating liquid, there were no problems in handling.
C: There were no problems in handling immediately after the preparation of the ink receiving layer-coating liquid.
D: The increase in the viscosity was significant, and handling was impossible.

State of Coated Surface

For each inkjet recording medium, the degree of occurrence of film cracks and “comet with nucleus” defects occurring on the surface of the ink receiving layer at the time of drying the coating, were evaluated by visual inspection, and ranked according to the following criteria.

—Evaluation Criteria—

A: Film cracks and defects did not occur.

B: Film cracks and defects occurred to a slight but insignificant degree.

C: Occurrence of film cracks and defects could be noticed.

D: The extent of film cracks and defects was at a problematic level.

Brittleness

In ambient conditions of 23° C. and 15% RH, an inkjet recording medium cut to a size of 3 cm×10 cm was left to stand overnight, and then was wound around cylinders of various types with different diameters, such that the outer surface became the image-receiving layer surface. It was evaluated by visual inspection as to whether cracks occurred at the ink receiving layer. The inkjet recording media were further ranked as follows, based on the diameter of the smallest cylinder at which cracks did not occur.

—Evaluation Criteria—

A: Cracks did not occur until the diameter of the cylinder was reduced to 10 mm.

B: Cracks did not occur until the diameter of the cylinder was reduced to 20 mm.

C: Cracks did not occur until the diameter of the cylinder was reduced to 30 mm.

D: Cracks occurred when the cylinder had a diameter larger than 30 mm.

TABLE 1

| | Under | Lower layer | | | | | | Upper layer | | | | |
|---|---|---|---|---|---|---|---|---|---|---|---|---|
| | coat | | Type | | | | | | Type | | | |
| | layer | | of | | | | | | of | | | |
| | *1 | *2 | PVA | *3 | *4 | *1 | *5 | *2 | PVA | *3 | *4 | *6 |
| Test Ex. 1 | Present | A1 | *8 | — | — | Absent | — | — | | | | |
| Test Ex. 2 | Present | A2 | *8 | HPC- | — | Absent | — | — | | | | |
| | | | | SSL | | | | | | | | |
| Test Ex. 3 | Present | A3 | *8 | HPC- | *9 | Absent | — | — | | | | |
| | | | | SSL | | | | | | | | |
| Test Ex. 4 | Present | A3 | *8 | HPC- | *9 | Absent | — | B1 | PVA- | — | *9 | — |
| | | | | SSL | | | | | 235 | | | |
| Test Ex. 5 | Present | A3 | *8 | HPC- | *9 | Absent | PVA- | B2 | PVA- | — | — | *10 |
| | | | | SSL | | | 235 | | 235 | | | |
| Test Ex. 6 | Present | A3 | *8 | HPC- | *9 | Absent | PVA- | B3 | PVA- | HPC- | *9 | *10 |
| | | | | SSL | | | 235 | | 235 | SSL | | |
| Test Ex. 7 | Present | A1 | *8 | — | — | Absent | PVA- | B2 | PVA- | — | — | *10 |
| | | | | | | | 235 | | 235 | | | |
| Test Ex. 8 | Present | A3 | *8 | HPC- | *9 | Absent | — | B2 | PVA- | — | — | *10 |
| | | | | SSL | | | | | 235 | | | |
| Test Ex. 9 | Absent | A3 | *8 | HPC- | *9 | Absent | — | B1 | PVA- | — | *9 | — |
| | | | | SSL | | | | | 235 | | | |

| | | | | | | | | |
|---|---|---|---|---|---|---|---|---|
| Test Ex. 10 | Absent | A4 | *8 | — | *9 | Present | — | — |

| | | Evaluation | | | | | |
|---|---|---|---|---|---|---|---|
| | | | | | | State | |
| | | | | | Coating | of | |
| | | | Ozone | | liquid | coated | |
| | *7 | *11 | resistance | Density | stability | surface | Brittleness |
| Test Ex. 1 | *10 | B | A | B | A | A | A |
| Test Ex. 2 | *10 | A | A | B | B | A | B |
| Test Ex. 3 | *10 | A | A | B | C | C | B |
| Test Ex. 4 | *10 | A | A | A | A | A | A |
| Test Ex. 5 | — | A | A | A | A | A | A |
| Test Ex. 6 | — | A | A | B | B | B | B |
| Test Ex. 7 | — | C | A | A | A | B | A |
| Test Ex. 8 | — | A | A | A | A | B | A |
| Test Ex. 9 | *10 | A | C | A | A | A | A |
| Test Ex. 10 | — | C | C | C | C | C | B |

*1: Magnetic chloride
*2: Type of coating liquid
*3: Water-soluble cellulose
*4: Water-soluble aluminum compound
*5: Intermediate layer
*6: Water-soluble multifunctional crosslinking agent
*7: Crosslinking solution
*8: Acetoactyl-modified PVA
*9: Polyaluminum chloride
*10: Adipic acid dihydrazide
*11: Moisture resistance (bleeding)

As is shown in the above Table 1, in Test Examples 1 to 8, there were obtained ink receiving layers having a good state of coated surface and reduced brittleness, while favorably maintaining the stability of the coating liquid used in the coating. After the recording, the ozone resistance was good, and the bleeding of the images was suppressed.

In contrast, with respect to Test Examples 9 and 10 in which magnesium chloride was not present in the undercoat layer, ozone resistance could not be secured. Furthermore, when magnesium chloride was incorporated into the coating film-forming liquid, not only ozone resistance could not be secured, but also the coating liquid stability or the state of coated surface was deteriorated. Furthermore, the bleeding in the image after recording became deteriorated.

### Example 1

### Preparation of Ink Set 1

Preparation of Yellow Ink Y-101

Ion exchange water was added to the following components to make 1 liter, and the mixture was stirred for 1 hour while heating at a temperature of 30 to 40° C. After that, the solution was filtered under reduced pressure through a micro filter having an average pore diameter of 0.25 μm to prepare yellow ink (Y-101).

Yellow Ink: Prescription of Y-101

| Solids Content | | |
|---|---|---|
| Yellow dye | 60.0 | g/liter |
| (potassium salt of yellow dye Y-1 | | |
| represented by the following structural formula) | | |
| PROXEL XL-2 | 1.0 | g/liter |
| (manufactured by Avecia Inkjet Limited) | | |
| Liquid Components | | |
| Glycerol | 81 | g/liter |
| Triethylene glycol | 96 | g/liter |
| Triethylene glycol monobutyl ether | 94 | g/liter |
| OLFINE E1010 | 20 | g/liter |
| (manufactured by Shin-Etsu Chemical Co., Ltd.) | | |

Yellow Dye Y-1

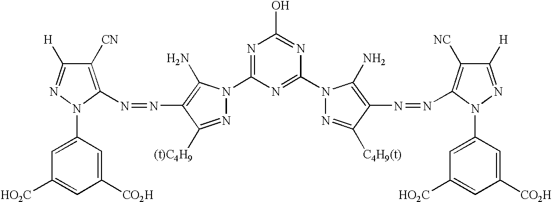

Preparation of Cyan Ink C-101

Ion exchange water was added to the following components to make 1 liter, and the mixture was stirred for 1 hour while heating at a temperature of 30 to 40° C. After that, the solution was filtered under reduced pressure through a micro filter having an average pore diameter of 0.25 μm to prepare cyan ink (C-101).

Prescription of Cyan Ink C-101

| Solids Content | | |
|---|---|---|
| Cyan dye | 54.0 | g/liter |
| (cyan dye C-1 represented by the | | |
| following structural formula) | | |
| Urea | 41.0 | g/liter |
| PROXEL XL-2 | 1.0 | g/liter |
| (manufactured by Avecia Inkjet Limited) | | |
| Liquid Components | | |
| Glycerol | 91 | g/liter |
| Triethylene glycol | 18 | g/liter |
| Triethylene glycol monobutyl ether | 97 | g/liter |
| 1,2-Hexanediol | 12 | g/liter |
| 2-Pyrrolidone | 27 | g/liter |
| OLFINE E1010 | 10 | g/liter |
| (manufactured by Shin-Etsu Chemical Co., Ltd.) | | |

Cyan Dye C-1

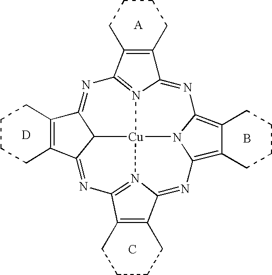

One of rings A to D represents:

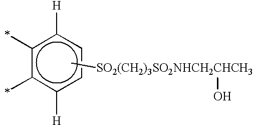

Remaining three rings
each represent:

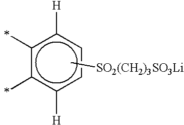

*indicates a bonding site of a phthalocyanine ring.

Preparation of Magenta Ink M-101

Ion exchange water was added to the following components to make 1 liter, and the mixture was stirred for 1 hour while heating at a temperature of 30 to 40° C. After that, the solution was filtered under reduced pressure through a micro filter having an average pore diameter of 0.25 μm to prepare magenta ink (M-101).

Prescription of Magenta Ink M-101

Solids Content

| | | |
|---|---|---|
| Magenta dye (compound identified by MAGENTA-1 | 30.0 | g/liter |
| described in JP-A No. 2007-138124) | | |
| PROXEL XL-2 (manufactured by Avecia Inkjet Limited) | 1.0 | g/liter |
| Urea | 48 | g/liter |

Liquid Components

| | | |
|---|---|---|
| Glycerol | 84 | g/liter |
| Triethylene glycol | 122 | g/liter |
| Betaine Compound | 17 | g/liter |
| (Betaine-1 described in paragraph [0901] of JP-A | | |
| No. 2007-138124) | | |

Preparation of Black Ink Bk-101

Ion exchange water was added to the following components to make 1 liter, and the mixture was stirred for 1 hour while heating at a temperature of 30 to 40° C. After that, the solution was filtered under reduced pressure through a micro filter having an average pore diameter of 0.25 μm to prepare black ink (Bk-101).

Prescription of Black Ink Bk-101

| Solids Content | | |
|---|---|---|
| Black dye 1 (main dye Bk-1 for black shown below) | 62.0 | g/liter |
| Black dye 2 (complementary dye Bk-2 for black shown below) | 10.0 | g/liter |
| PROXEL XL-2 (manufactured by Avecia Inkjet Limited) | 1.0 | g/liter |
| Liquid Components | | |
| Glycerol | 83 | g/liter |
| Triethylene glycol | 11 | g/liter |
| Triethylene glycol monobutyl ether | 84 | g/liter |
| 1,2-Hexanediol | 16 | g/liter |
| OLFINE E1010 (manufactured by Shin-Etsu Chemical Co., Ltd.) | 10 | g/liter |

Main dye Bk-1 for black

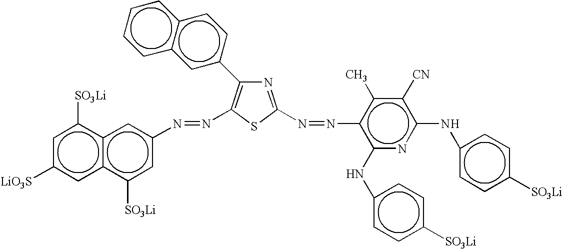

Complementary Dye Bk-2 for Black

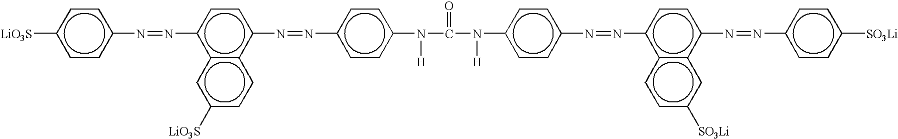

A pure ink for an inkjet printer MP 610 (manufactured by Canon Inc.) that is different from the ink used in the invention was selected to use for ink set 2.

Preparation of Inkjet Recording Medium

Inkjet recording media (1) to (10) obtained in the above-described Test Examples were prepared.

With respect to the above-described ink set 1, the ink set for an inkjet printer A700 (manufactured by Seiko Epson Corporation) was replaced by the ink set 1 and the following evaluation was conducted using the inkjet recording media described in the following Table 2.

With respect to the above-described ink set 2, the inkjet printer MP 610 (manufactured by Canon Inc.) and the pure ink for the inkjet printer MP 610 were used in combination and the following evaluation was conducted using the inkjet recording media described in the following Table 2. The evaluation results are shown in the following Table 2.

### Evaluation

### Moisture Resistance (Bleeding)

A lattice-shaped pattern in which magenta and black portions are formed adjacently (length of a side of each inner square is 0.28 mm) was printed to form a 3 cm square image on the respective inkjet recording media in ambient conditions of 23° C. and 50% RH. Immediately after the printing, the inkjet recording media were transferred to ambient conditions at 23° C. and 90% RH, and were left to stand for 7 days. After 7 days, the inkjet recording media were sufficiently dried under ambient conditions of 23° C. and 50% RH, and then the degree of bleeding was evaluated by visual inspection. The inkjet recording media were ranked according to the following evaluation criteria.

—Evaluation Criteria—

A: Bleeding was not observed.

B: Slight bleeding was observed, the extent of the bleeding was not noticeable in terms of ordinary use.

C: There was a noticeable level of bleeding, but the level was practically acceptable.

D: Bleeding was significant and not practically acceptable.

Light Resistance

Light resistance life duration was evaluated according to the Digital Core Photo Print Stability Standard (JEITA CP-3901). Each sample was printed in an environment of 23° C. and 50% RH, and then dried in the same environment for 24 hours. Thereafter, the sample was placed in a light resistance tester ATLAS ci5000 available from ATLAS Co., Ltd. During the test, a UV cut filter SC-37 (manufactured by FUJIFILM CORPORATION) was used. The illuminance during the test was 70000 lux and the temperature and humidity in the testing chamber were 25° C. and 50% RH. The reflection densities before and after the test were measured with a reflection density meter (Xrite 938, manufactured by X-Rite Inc.).

—Evaluation Criteria—

A: Life duration is 150 years or more.

B: Life duration is 100 years or more, but less than 150 years.

C: Life duration is 50 years or more, but less than 100 years.

D: Life duration is less than 50 years.

Ozone Resistance

Ozone resistance life duration was evaluated according to the Digital Core Photo Print Stability Standard (JEITA CP-3901). Each sample was printed in an environment of 23° C. and 50% RH, and then dried in the same environment for 24 hours. Thereafter, the sample was placed in an ozone chamber. The ozone concentration in the ozone chamber was 5 ppm and the temperature and humidity therein were 25° C. and 50% RH. The reflection densities before and after the test were measured with a reflection density meter (Xrite 938, manufactured by X-Rite Inc.).

—Evaluation Criteria—

A: Life duration is 20 years or more.

B: Life duration is 10 years or more, but less than 20 years.

C: Life duration is 5 years or more, but less than 10 years.

D: Life duration is less than 5 years.

Print Density

A black (K) solid image was printed on each of the inkjet recording media obtained in the Test Examples in an environment of 23° C. and 50% RH. Optical densities (O. D.) were measured with a reflection density meter (Xrite 938, manufactured by X-Rite Inc.).

—Evaluation Criteria—

A: Density is 2.3 or more.

B: Density is 2.15 or more but less than 2.3.

C: Density is 2.0 or more but less than 2.15.

D: Density is less than 2.0

TABLE 2

| | Inkjet | | | | | | |
|---|---|---|---|---|---|---|---|
| | Recording | Ink | | | | Print | |
| | Medium | Set | *21 | *22 | *23 | Density | Remarks |
| Test | (1) | 1 | B | B | B | B | Invention |
| Ex. 11 | | | | | | | |
| Test | (2) | 1 | A | B | B | B | Invention |
| Ex1.2 | | | | | | | |
| Test | (3) | 1 | A | A | A | B | Invention |
| Ex. 13 | | | | | | | |
| Test | (4) | 1 | A | A | A | A | Invention |
| Ex. 14 | | | | | | | |
| Test | (5) | 1 | A | A | A | A | Invention |
| Ex. 15 | | | | | | | |
| Test | (6) | 1 | A | A | A | B | Invention |
| Ex. 16 | | | | | | | |
| Test | (7) | 1 | C | B | B | A | Invention |
| Ex. 17 | | | | | | | |
| Test | (8) | 1 | A | A | A | A | Invention |
| Ex. 18 | | | | | | | |
| Test | (9) | 1 | A | B | C | A | Comparison |
| Ex. 19 | | | | | | | |
| Test | (10) | 1 | D | A | C | C | Comparison |
| Ex. 20 | | | | | | | |
| Test | (1) | 2 | B | C | C | B | Comparison |
| Ex. 21 | | | | | | | |
| Test | (2) | 2 | A | C | C | B | Comparison |
| Ex. 22 | | | | | | | |
| Test | (3) | 2 | A | C | C | B | Comparison |
| Ex. 23 | | | | | | | |

*21: Moisture resistance
*22: Light resistance
*23: Ozone resistance

From the results shown in Table 2, it is understood that when these inkjet recording media and the ink according to the invention are used in combination, these combinations are excellent in terms of any of the above evaluations.

All publications, patent applications, and technical standards mentioned in this specification are herein incorporated by reference to the same extent as if each individual publication, patent application, or technical standard was specifically and individually indicated to be incorporated by reference.

What is claimed is:

1. An inkjet recording method comprising:
recording an image by applying at least one ink selected from the group consisting of an ink containing a water-soluble dye represented by the following Formula (M), an ink containing a water-soluble dye represented by the following Formula (BK), an ink containing a water-soluble dye represented by the following Formula (Y), and an ink containing a water-soluble dye represented by the following Formula (C), according to an inkjet process, to an inkjet recording medium produced by a method comprising:
forming an undercoat layer by applying an undercoat layer-forming liquid, containing a binder resin and a water-soluble divalent metal salt, to a support;
forming a coating film by coating a coating film-forming liquid, containing at least inorganic fine particles and an acetoacetyl-modified polyvinyl alcohol, on the undercoat layer; and
applying a curing solution, containing a water-soluble multifunctional compound having two or more amino groups in the molecule, to the coating film either simultaneously with the forming of the coating film or before the coating film undergoes decreasing-rate drying during drying of the coating film: 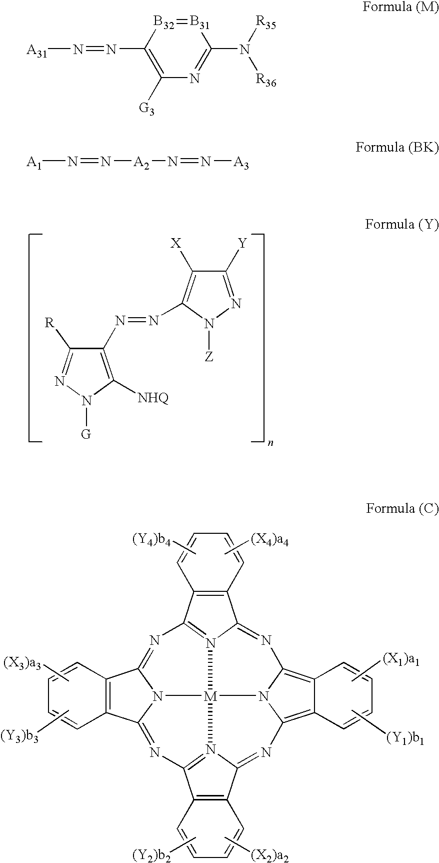
wherein, in Formula (M), A₃₁ represents a 5-membered heterocyclic group; B₃₁ and B₃₂ each represent ═CR₃₁—, or —CR₃₂═ or, alternatively, one of B₃₁ and B₃₂ is a nitrogen atom, and the other is ═CR₃₁—, or —CR₃₂═; R₃₅ and R₃₆ each independently represent a hydrogen atom, an aliphatic group, an aromatic group, a heterocyclic group, an acyl group, an alkoxycarbonyl group, an aryloxycarbonyl group, a heterocyclic oxycarbonyl group, a carbamoyl group, an alkylsulfonyl group, an arylsulfonyl group, a heterocyclic sulfonyl group, or a sulfamoyl group; G₃, R₃₁, and R₃₂ each independently represent a hydrogen atom, a halogen atom, an aliphatic group, an aromatic group, a heterocyclic group, a cyano group, a carboxyl group, a carbamoyl group, an alkoxycarbonyl group, an aryloxycarbonyl group, a heterocyclic oxycarbonyl group, an acyl group, a hydroxyl group, an alkoxy group, an aryloxy group, a heterocyclic oxy group, a silyloxy group, an acyloxy group, a carbamoyloxy group, an alkoxycarbonyloxy group, an aryloxycarbonyloxy group, an amino group (including arylamino groups and heterocyclic amino groups), an acylamino group, a ureido group, a sulfamoylamino group, an alkoxycarbonylamino group, an aryloxycarbonylamino group, an alkylsulfonylamino group, an arylsulfonylamino group, a heterocyclic sulfonylamino group, a nitro group, an alkylthio group, an arylthio group, an alkylsulfonyl group, an arylsulfonyl group, a heterocyclic sulfonyl group, an alkylsulfinyl group, an arylsulfinyl group, a heterocyclic sulfinyl group, a sulfamoyl group, a sulfonic acid group or a heterocyclic thio group; and R₃₁ and R₃₅, or R₃₅ and R₃₆, may bond with each other to form a 5- or 6-membered ring, providing that at least one of A₃₁, R₃₁, R₃₂, R₃₅, R₃₆ and G₃ has a sulfonic acid group and the sulfonic acid group has Li⁺ or a quaternary ammonium ion as a counter ion;
wherein, in Formula (BK), A₁, A₂, and A₃ each independently represent an aromatic group or a heterocyclic group; A₁ and A₃ are a monovalent group; and A₂ is a divalent group;
wherein, in Formula (Y), G represents a heterocyclic group; R, X, Y, Z, and Q each represent a monovalent, divalent, or trivalent group; n represents an integer of 1 to 3; when n is 1, R, X, Y, Z, Q and G each represent a monovalent group; when n is 2, R, X, Y, Z, Q and G each represent a monovalent or divalent group provided that at least one of R, X, Y, Z, Q or G represents a divalent substituent; and when n is 3, R, X, Y, Z, Q and G each represent a monovalent, divalent, or trivalent group and at least two of R, X, Y, Z, Q or G represent a divalent substituent or at least one of R, X, Y, Z, Q or G represents a trivalent substituent; and
wherein, in Formula (C), X₁, X₂, X₃, and X₄ each independently represent —SO—Z, —SO₂—Z, —SO₂NV₁V₂, —CONV₁V₂, —CO₂Z, —CO—Z, or a sulfo group; each Z independently represents an alkyl group, a cycloalkyl group, an alkenyl group, an alkynyl group, an aralkyl group, an aryl group, or a heterocyclic group; V₁ and V₂ may be the same or different and each represent a hydrogen atom, an alkyl group, a cycloalkyl group, an alkenyl group, an alkynyl group, an aralkyl group, an aryl group, or a heterocyclic group; each of the substituents represented by Z, V₁ and V₂ may further have a substituent; Y₁, Y₂, Y₃, and Y₄ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryloxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group; each group may further have a substituent; a₁ to a₄ and b₁ to b₄ each represent the number of substituents of X₁ to X₄ and Y₁ to Y₄, respectively; a₁ to a₄ each independently represent an integer of from 0 to 4, provided that a₁ to a₄ are not all 0 at the same time; b₁ to b₄ each independently represent an integer of from 0 to 4; M represents a hydrogen atom, a metal atom, oxides thereof, hydroxides thereof, or halides thereof; providing that at least one of X₁, X₂, X₃, X₄, Y₁, Y₂, Y₃, or Y₄ is an ionic hydrophilic group or a group having an ionic hydrophilic group as a substituent.

2. The inkjet recording method according to claim 1, wherein the curing solution further contains inorganic fine particles and a polyvinyl alcohol other than the acetoacetyl-modified polyvinyl alcohol.

3. The inkjet recording method according to claim 1, wherein the coating film-forming liquid comprises a first solution containing at least inorganic fine particles and acetoacetyl-modified polyvinyl alcohol and a second solution containing at least inorganic fine particles and a polyvinyl alcohol other than the acetoacetyl-modified polyvinyl alcohol, and the forming of the coating film comprises a process of forming a multi-layered coating film by a simultaneous multilayer coating so that the second solution is disposed above the first solution.

4. The inkjet recording method according to claim 3, wherein at least one of the first solution or the second solution contains a water-soluble cellulose.

5. The inkjet recording method according to claim 1, wherein the coating film-forming liquid contains a water-soluble aluminum solution.

6. The inkjet recording method according to claim 3, wherein the curing solution further contains inorganic fine particles and a polyvinyl alcohol other than the acetoacetyl-modified polyvinyl alcohol, and according to the simultaneous multilayer coating, in the following order, the first solution, the second solution and the curing solution are coated on the undercoat layer formed on the support, thereby forming a multi-layered coating film on the undercoat layer.

7. The inkjet recording method according to claim 1, wherein the compound represented by Formula (Y) is a compound represented by the following Formula (Y-1): 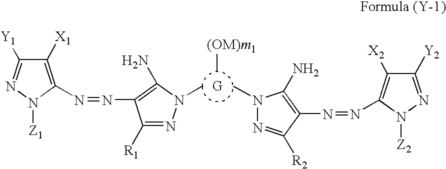
wherein, in Formula (Y-1), R₁, R₂, X₁, X₂, Y₁, Y₂, Z₁, and Z₂ each independently represent a monovalent group; G represents an atomic group necessary to form a 5- to 8-membered nitrogen-containing hetero ring; M represents a hydrogen atom or a cation, and m₁ represents an integer of 0 to 3.

8. The inkjet recording method according to claim 1, wherein the compound represented by Formula (Y) is a yellow dye having an oxidation potential that is more noble than 1.0 V (SCE).

9. The inkjet recording method according to claim 1, wherein the compound represented by Formula (Y) is a yellow dye having a value of λmax in the range of 390 nm to 470 nm and having a ratio of I (λmax+70 nm)/I (λmax) of 0.2 or less wherein I (λmax+70 nm) represents light absorbance at λmax+70 nm and I (λmax) represents light absorbance at λmax.

10. The inkjet recording method according to claim 1, wherein the compound represented by Formula (C) is a compound represented by the following Formula (C-2) or a salt thereof: 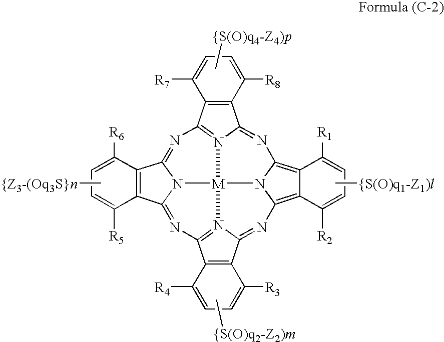
wherein, in Formula (C-2), R₁, R₂, R₃, R₄, R₅, R₆, R₇, and R₈ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryl oxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group; these groups may further have a substituent; Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group; at least one of Z₁, Z₂, Z₃, or Z₄ has an ionic hydrophilic group as a substituent; l, m, n, p, q₁, q₂, q₃, and q₄ each independently represent an integer of 1 or 2; and M is the same as M in Formula (C).

11. The inkjet recording method according to claim 1, wherein the compound represented by Formula (C) is a compound represented by the following Formula (C-3) or a salt thereof: 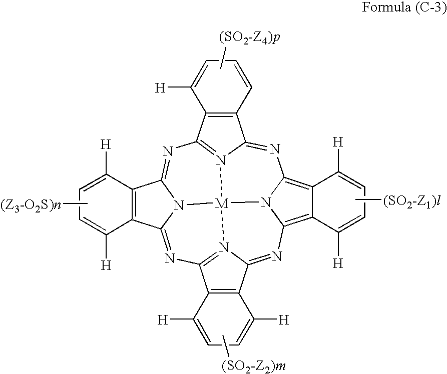
wherein, in Formula (C-3), R₁, R₂, R₃, R₄, R₅, R₆, R₇, and R₈ each independently represent a hydrogen atom, a halogen atom, an alkyl group, a cycloalkyl group, an alkenyl group, an aralkyl group, an aryl group, a heterocyclic group, a cyano group, a hydroxyl group, a nitro group, an amino group, an alkylamino group, an alkoxy group, an aryl oxy group, an amide group, an arylamino group, a ureido group, a sulfamoylamino group, an alkylthio group, an arylthio group, an alkoxycarbonylamino group, a sulfonamide group, a carbamoyl group, a sulfamoyl group, a sulfinyl group, a sulfonyl group, an alkoxycarbonyl group, a heterocyclic oxy group, an azo group, an acyloxy group, a carbamoyloxy group, a silyloxy group, an aryloxy carbonyl group, an aryloxycarbonylamino group, an imido group, a heterocyclic thio group, a phosphoryl group, an acyl group, or an ionic hydrophilic group; these groups may further have a substituent; Z₁, Z₂, Z₃, and Z₄ each independently represent a substituted or unsubstituted alkyl group, a substituted or unsubstituted cycloalkyl group, a substituted or unsubstituted alkenyl group, a substituted or unsubstituted alkynyl group, a substituted or unsubstituted aralkyl group, a substituted or unsubstituted aryl group, or a substituted or unsubstituted heterocyclic group; at least one of Z₁, Z₂, Z₃, or Z₄ has an ionic hydrophilic group as a substituent; l, m, n, p, q₁, q₂, q₃, and q₄ each independently represent an integer of 1 or 2; and M is the same as M in Formula (C).

12. The inkjet recording method according to claim 1, wherein a cyan ink having a relatively high color density and a cyan ink having a relatively low color density are contained in an ink set as the cyan ink and the cyan ink having a relatively low color density contains a compound represented by the following Formula (C-4) or a salt thereof: 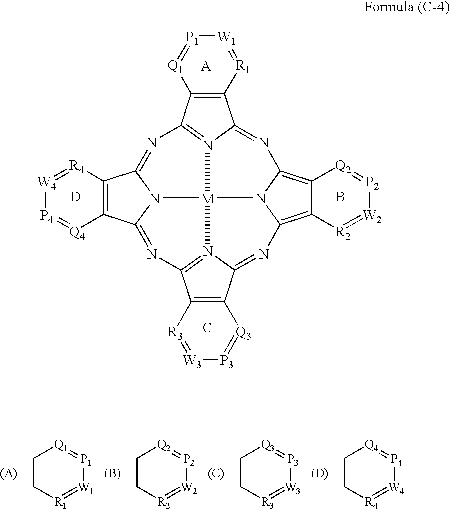
wherein, in Formula (C-4), Q₁ to Q₄, P₁ to P₄, W₁ to W₄, and R₁ to R₄ each independently represent (═C(J₁)— and/or —N═), (═C(J₂)— and/or —N═), (═C(J₃) and/or —N═), or (═C(J₄)— and/or —N═); J₁ to J₄ each independently represent a hydrogen atom and/or a substituent; and at least one of ring (A), ring (B), ring (C), or ring (D), constituted by (Q₁, P₁, W₁, and R₁), (Q₂, P₂, W₂, R₂), (Q₃, P₃, W₃, R₃), or (Q₄, P₄, W₄, R₄), is a heterocyclic ring.

13. The inkjet recording method according to claim 1, wherein the binder resin in the undercoat layer is gelatin or polyvinyl alcohol.

14. The inkjet recording method according to claim 1, wherein the water-soluble divalent metal salt in the undercoat layer is a water-soluble magnesium salt or a water-soluble calcium salt.

15. The inkjet recording method according to claim 1, wherein the water-soluble multifunctional compound having two or more amino groups in the molecule in the curing solution is an amine compound or a hydrazine compound.

16. The inkjet recording method according to claim 1, wherein the support is a resin coated paper.
